(19) United States
(12) Patent Application Publication
(10) Pub. No.: US 2007/0044767 A1
(43) Pub. Date: Mar. 1, 2007

(54) Fuel injection system for internal combustion engine

(75) Inventors: Susumu Kojima, Susono-shi (JP); Motonari Yarino, Suntou-gun (JP); Tomojiro Sugimoto, Susono-shi (JP); Yukio Koseki, Susono-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/508,318

(22) Filed: Aug. 23, 2006

(30) Foreign Application Priority Data
Aug. 30, 2005 (JP) 2005-250135

(51) Int. Cl. F02M 61/14

(52) U.S. Cl. 123/470

(57) ABSTRACT

The base end portion of an injector is connected to a delivery pipe. A fuel passage, through which the fuel in the delivery pipe flows close by an injection port formed in the front end portion of a valve body and is then returned to the delivery pipe, is formed in the injector. Even if communication between the fuel passage and the injection port is blocked by a needle valve, the fuel constantly flows close to the injection port while circulating in the fuel injection system, Also, part of the fuel flowing through the fuel passage is injected from the injection port to a combustion chamber by permitting the communication between the fuel passage and the injection port.

### INCORPORATION BY REFERENCE

The disclosure of Japanese Patent Application No. 2005-250135 filed on Aug. 30, 2005 including the specification, drawings and abstract is incorporated herein by reference in its entirety.

### BACKGROUND OF THE INVENTION

1. Field of the Invention

The invention relates to a fuel injection system for an internal combustion engine, in which a predetermined amount of fuel is injected to a combustion chamber or an intake port.

2. Description of the Related Art

A direct injection internal combustion engine, in which fuel is injected not to an intake port but directly into a combustion chamber, is known. In such direct injection internal combustion engine, air is taken in the combustion chamber from the intake port when an intake valve is open, and compressed by a piston. Then, fuel is directly injected from an injector to the compressed air having high pressure, and the compressed air in the combustion chamber is mixed with the atomized fuel. The air-fuel mixture is ignited by a spark plug, and then expands. A driving force is thus obtained. When an exhaust valve is open, the exhaust gas produced by combustion is discharged from an exhaust port.

In such direct injection internal combustion engine, the injector is configured such that a needle valve is movably supported in a housing having an injection port at its end, a force is applied to the needle valve so that the needle valve blocks a fuel passage, and when electric power is supplied to a solenoid, the needle valve is moved by the electromagnetic force, thereby opening the fuel passage. Opening the fuel passage by moving the needle valve at predetermined time makes it possible to inject the fuel present in the fuel passage from the injection port into the combustion chamber.

In the injector used in the direct injection internal combustion engine, a predetermined amount of fuel is kept pressurized, and the fuel having a predetermined pressure is injected from the injection port while the fuel passage is opened by the needle valve. Accordingly, even if the needle valve blocks the fuel passage after the fuel injection period has elapsed, some fuel adheres around the injection port without being injected into the combustion chamber. In this case, the remaining fuel is baked by the combustion gas generated in the combustion chamber, and accumulated, as deposit, on the inner face of the injection port and the apical surface of the needle valve. The accumulated deposit reduces the passage area of the fuel passage, thereby increasing the resistance to the flow of the fuel. The amount of fuel flowing through the fuel passage is reduced, and the fuel injection amount varies. As a result, the fuel is not burned appropriately.

If the fuel remains near the injection port, even if the fuel passage is opened by the needle valve when the next fuel injection period starts, the injected fuel is not atomized sufficiently due to the remaining fuel. Accordingly, the level of atomization of the fuel may be low at the beginning of fuel injection. During idling, problems may occur, for example, the torque fluctuates, or the exhaust gas characteristics deteriorate.

In order to solve these problems, the front end portion of the injector is cooled to suppress accumulation of the deposit. For example, Japanese Patent Application Publication No. JP-A-07-301166 describes a cooling apparatus for an injection nozzle. In the cooling apparatus, the outer cylinder of a needle valve is closed at the valve seat side. Also, the upper portion of the inner wall of the outer cylinder is engaged with the outer wall of the inner cylinder. The thus obtained clearance between the outer cylinder and the inner cylinder is used as a cooling fuel passage through which the cooled fuel flows between the shaft hole of the cylinder and the inside of the needle valve. The inside of the needle valve is cooled by causing the low-pressure fuel to flow through the passage extending from the low-pressure fuel inlet to the shaft hole formed in the upper portion of the inner cylinder through the pore formed in the outer wall of the outer cylinder on the sliding seal portion.

Japanese Patent Application Publication No. JP-08-200183 describes a fuel injection valve for an internal combustion engine. The fuel can be supplied from a fuel high-pressure supply passage to an oil reservoir chamber, and the fuel injection valve is cooled by discharging the fuel in the oil reservoir chamber through a fuel circulation passage and a fuel oil passage. When fuel injection is performed, communication is provided between the oil reservoir chamber and an injection hole, and the fuel oil passage is blocked, whereby the fuel in the oil reservoir chamber is injected from an injection port.

However, in the cooling apparatus for an injection nozzle described in Japanese Patent Application Publication No. JP-A-07-301166, the high-pressure fuel passage, through which the fuel to be injected from the injection port flows, is formed, and the cooled fuel passage, through which the low-pressure fuel flows, is formed in addition to the high-pressure fuel passage. Accordingly, the number of fuel passages in the injector increases, which complicates the structure and increases the size of the injector. In the fuel injection valve for an internal combustion engine described in Japanese Patent Application Publication No. JP-A-08-200183, usually, the fuel injection valve is cooled by discharging the fuel in the oil reservoir chamber through the fuel oil circulation passage and the fuel oil passage. When fuel injection is performed, the fuel oil passage is blocked, and the fuel in the oil reservoir chamber is injected through the injection port. Accordingly, when fuel injection is performed, it is difficult to cool the fuel injection valve, which reduces the cooling performance.

### SUMMARY OF THE INVENTION

The invention provides a compact fuel injection system for an internal combustion engine, which has a simple structure and improved cooling performance.

An aspect of the invention relates to a fuel injection system for an internal combustion engine. The fuel injection system includes a fuel injection device; a fuel injection port formed in the front end portion of the fuel injection device; a fuel passage through which fuel supplied from the outside of the fuel injection device flows close to the fuel injection port and is then discharged to the outside of the fuel injection device; and a fuel injection valve that permits communication between the fuel passage and the fuel injection port to inject part of the fuel flowing through the fuel passage.

As described so far, the fuel injection system for an internal combustion engine according to the invention includes the fuel injection port formed in the front end portion of the fuel injection device; and the fuel passage through which fuel supplied from the outside of the fuel injection device flows close to the fuel injection port and is then discharged to the outside of the fuel injection device. Also, the fuel injection valve permits communication between the fuel passage and the fuel injection port to inject part of the fuel flowing through the fuel passage. Accordingly, the fuel passage can be used as both the passage, through which the fuel to be injected flows, and the passage, through which the fuel used to cool the front end portion of the fuel injection device flows. It is, therefore, possible to provide the compact fuel injection system having a simple structure. It is also possible to improve the cooling performance by causing the fuel to constantly flow through the fuel passage during circulation in the fuel injection system to cool the front end portion of the fuel injection device.

### BRIEF DESCRIPTION OF THE DRAWINGS

The foregoing and further objects, features and advantages of the invention will become apparent from he following description of example embodiments with reference to the accompanying drawings, wherein the same or corresponding portions will be denoted by the same reference numerals and wherein:

FIG. 1 is the cross sectional view showing an injector in a fuel injection system for an internal combustion engine according to a first embodiment of the invention;

FIG. 2 is the cross sectional view taken along line II-II in FIG. 1;

FIG. 3 is the cross sectional view taken along line III-III in FIG. 1;

FIG. 4 is the cross sectional view showing the end portion of the injector in the fuel injection system for an internal combustion engine according to the first embodiment of the invention;

FIG. 5 is the cross sectional view taken along line V-V in FIG. 4;

FIG. 6 is the view schematically showing the structure of the fuel injection system for an internal combustion engine according to the first embodiment of the invention;

FIG. 7 is the cross sectional view showing an injector of a fuel injection system for an internal combustion engine according to a second embodiment of the invention;

FIG. 8 is the view schematically showing the structure of the fuel injection system for an internal combustion engine according to the second embodiment of the invention;

FIG. 9 is the cross sectional view showing an injector in a fuel injection system for an internal combustion engine according to a third embodiment of the invention;

FIG. 10 is the view schematically showing the structure of a fuel injection system for an internal combustion engine according to a fourth embodiment of the invention;

FIG. 11 is the view schematically showing the structure of a fuel injection system for an internal combustion engine according to a modified example of the fourth embodiment of the invention;

FIG. 12 is the view schematically showing the structure of a fuel injection system for an internal combustion engine according to a fifth embodiment of the invention;

FIG. 13 is the view schematically showing the structure of a high-pressure pump;

FIG. 14 is the view schematically showing the structure of a fuel injection system for an internal combustion engine according to a sixth embodiment of the invention;

FIG. 15 is the view schematically showing the structure of a fuel injection system for an internal combustion engine according to a modified example of the sixth embodiment of the invention;

FIG. 16 is the view schematically showing the structure of a fuel injection system for an internal combustion engine according to a seventh embodiment of the invention;

FIG. 17 is the view schematically showing the structure of a fuel injection system for an internal combustion engine according to a modified example of the seventh embodiment of the invention;

FIG. 18 is the view schematically showing the structure of a fuel injection system for an internal combustion engine according to an eighth embodiment of the invention;

FIG. 19 is the view schematically showing the structure of a fuel injection system for an internal combustion engine according to a modified example of the eighth embodiment of the invention;

FIG. 20 is the view schematically showing the structure of a fuel injection system for an internal combustion engine according to a ninth embodiment of the invention;

FIG. 21 is the flowchart of the fuel circulation control performed in a fuel injection system for an internal combustion engine according to a tenth embodiment of the invention;

FIG. 22 is the cross sectional view showing an injector in a fuel injection system for an internal combustion engine according to an eleventh embodiment of the invention;

FIG. 23 is the cross sectional view taken along line XXIII-XXIII in FIG. 22;

FIG. 24 is the cross sectional view taken along line XXIV-XXIV in FIG. 22;

FIG. 25 is the cross sectional view showing a core of an injector in a fuel injection system for an internal combustion engine according to a twelfth embodiment of the invention;

FIG. 26 is the cross sectional view showing an armature of the injector in the fuel injection system for an internal combustion engine according to the twelfth embodiment of the invention;

FIG. 27 is the cross sectional view showing a modified example of the armature of the injector in the fuel injection system for an internal combustion engine according to the twelfth embodiment;

FIG. 28 is the cross sectional view showing the upper face of a core of an injector in a fuel injection system for an internal combustion engine according to a thirteenth embodiment of the invention;

FIG. 29 is the cross sectional view showing the lower face of the core of the injector in the fuel injection system for an internal combustion engine according to the thirteenth embodiment of the invention;

FIG. 30 is the cross sectional view showing an armature of the injector in the fuel injection system for an internal combustion engine according to the thirteenth embodiment of the invention;

FIG. 31 is the cross sectional view showing the core and the armature of the injector according to the thirteenth embodiment of the invention;

FIG. 32 is the cross sectional view showing a core of an injector in a fuel injection system for an internal combustion engine according to a fourteenth embodiment of the invention;

FIG. 33 is the cross sectional view showing an armature of the injector in the fuel injection system for an internal combustion engine according to the fourteenth embodiment of the invention;

FIG. 34 is the cross sectional view showing a core of an injector in a fuel injection system for an internal combustion engine according to a fifteenth embodiment of the invention;

FIG. 35 is the view schematically showing a core and an armature of an injector in a fuel injection system for an internal combustion engine according to a sixteenth embodiment of the invention;

FIG. 36 is the vertical cross sectional view showing a core and an armature of an injector in a fuel injection system for an internal combustion engine according to a seventeenth embodiment of the invention;

FIG. 37 is the vertical cross sectional view showing a core and an armature of an injector in a fuel injection system for an internal combustion engine according to an eighteenth embodiment of the invention;

FIG. 38 is the vertical cross sectional view showing a core and an armature of an injector in a fuel injection system for an internal combustion engine according to a nineteenth embodiment of the invention;

FIG. 39 is the cross sectional view showing an injector in a fuel injection system for an internal combustion engine according to a twentieth embodiment of the invention;

FIG. 40 is the cross sectional view showing a fuel supply portion of the injector in the fuel injection system for an internal combustion engine according to the twentieth embodiment of the invention;

FIG. 41 is the cross sectional view showing a modified example of the fuel supply portion of the injector in the fuel injection system for an internal combustion engine according to the twentieth embodiment of the invention;

FIG. 42 is the cross sectional view showing another modified example of the fuel supply portion of the injector in the fuel injection system for an internal combustion engine according to the twentieth embodiment of the invention;

FIG. 43 is the cross sectional view showing another modified example of the fuel supply portion of the injector in the fuel supply system for an internal combustion engine according to the twentieth embodiment of the invention;

FIG. 44 is the cross sectional view showing another example of the fuel supply portion of the injector in the fuel supply system for an internal combustion engine according to the twentieth embodiment of the invention; and

FIG. 45 is the cross sectional view showing a connection portion at which an injector is connected to a delivery pipe in a fuel injection system for an internal combustion engine according to a twenty-first embodiment of the invention.

### DETAILED DESCRIPTION OF THE EXAMPLE EMBODIMENTS

Hereafter, fuel injection systems for an internal combustion engine according to example embodiments of the invention will be described in detail with reference to accompanying drawings. Note that, the invention is not limited to the example embodiments described below.

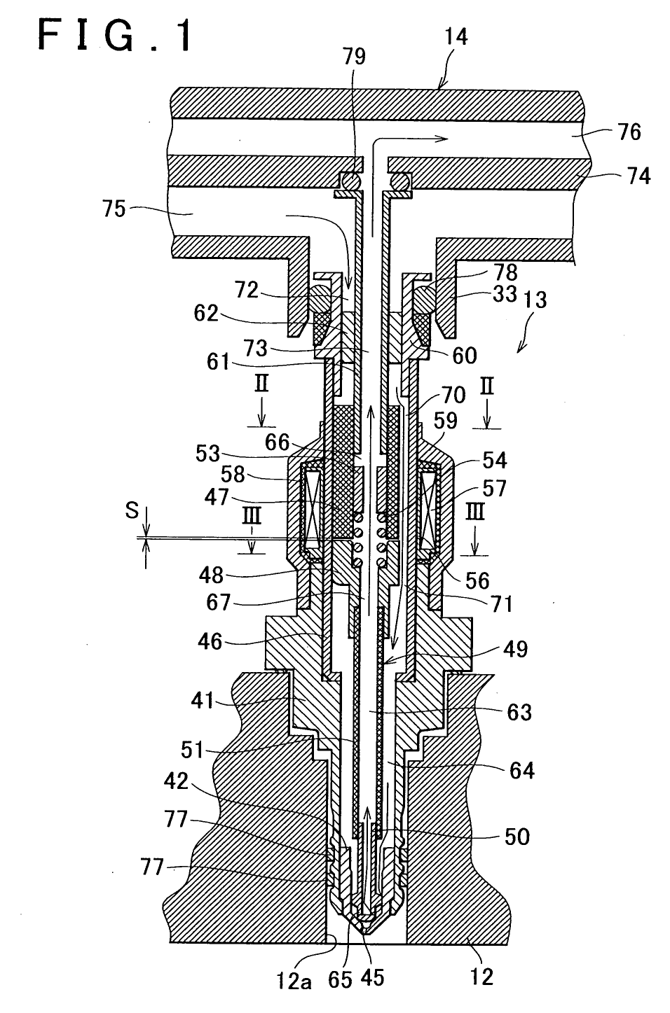

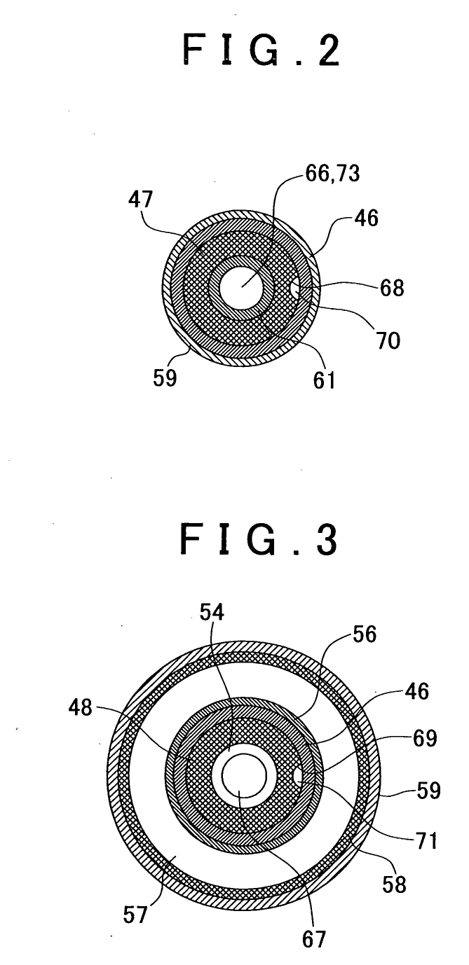

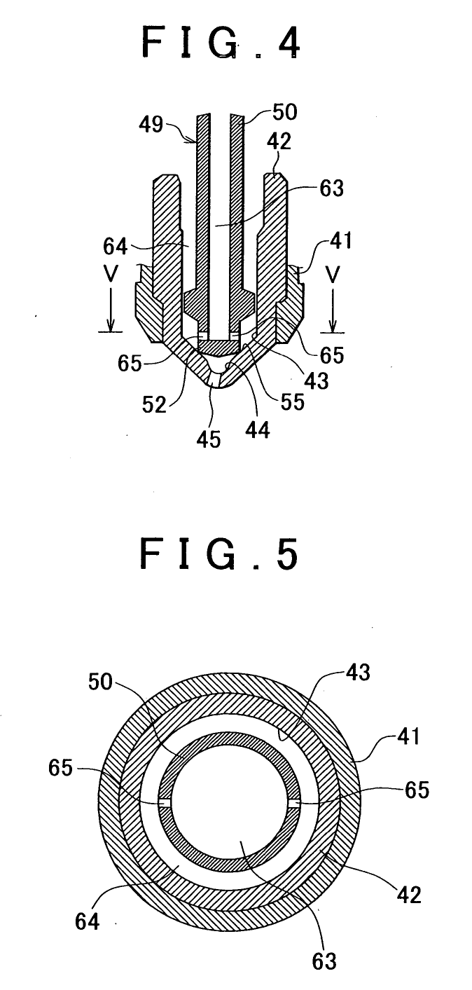

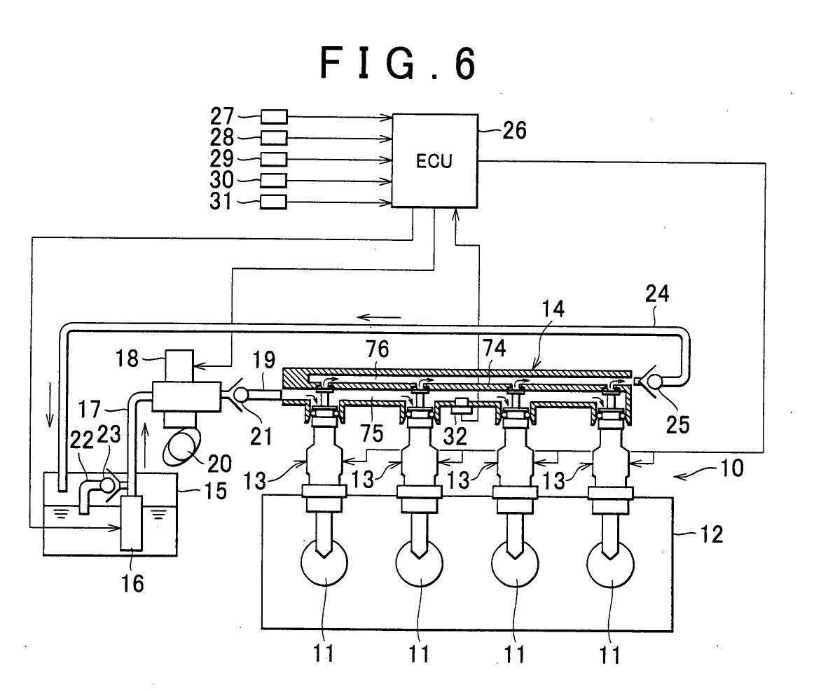

FIG. 1 is the cross sectional view showing an injector in a fuel injection system for an internal combustion engine according to a first embodiment of the invention. FIG. 2 is the cross sectional view taken along line II-II in FIG. 1. FIG. 3 is the cross sectional view taken along line III-III in FIG. 1. FIG. 4 is the cross sectional view showing the front end portion of the injector in the fuel injection system for an internal combustion engine according to the first embodiment of the invention. FIG. 5 is the cross sectional view taken along line V-V in FIG. 4. FIG. 6 is the view schematically showing the structure of the fuel injection system for an internal combustion engine according to the first embodiment of the invention.

In the fuel injection system for an internal combustion engine according to the first embodiment of the invention, an engine 10 is a direct-injection spark-ignition multi-cylinder internal combustion engine, as shown in FIG. 6. The engine 10 has four combustion chambers 11 corresponding to respective four cylinders. Injectors 13, which inject fuel directly into the respective combustion chambers 11, are fitted to a cylinder head 12. In addition, spark plugs (not shown) are fitted to the cylinder head 12. The base end portions of the injectors 13 are connected to a delivery pipe 14. The injectors 13 can inject the fuel having high-pressure (hereinafter, referred to as the “high-pressure fuel”) present in the delivery pipe 14 into the combustion chambers 11.

A fuel tank 15 can store a predetermined amount of gasoline fuel (hereinafter, referred to as “fuel”). A low-pressure feed pump 16 is arranged in the fuel tank 15. The low-pressure feed pump 16 is connected to a high-pressure pump 18 via a first fuel supply pipe 17. The high-pressure pump 18 is connected to the first end portion of the delivery pump 14 via a second fuel supply pipe 19. The high-pressure pump 18 is driven by a camshaft 20. The second fuel supply pipe 19 is provided with a check valve 21. The first fuel supply pipe 17 is provided with a return pipe 22, through which the fuel is sent back to the fuel tank 15. The return pipe 22 is provided with a check valve 23. The base end portion of a fuel discharge pipe 24 is connected to the second end portion of the delivery pipe 14. The other end portion of the fuel discharge pipe 24 is connected to the fuel tank 15. The fuel discharge pipe 24 is provided with a relief valve 25.

An electronic control unit (ECU) 26 is provided in a vehicle. The ECU 26 can control the injectors 13. The ECU 26 is connected to an air-flow sensor 27, a throttle position sensor 28, an accelerator pedal position sensor 29, an engine speed sensor 30, a coolant temperature sensor 31, etc. The ECU 26 sets the fuel injection amount and the fuel injection time based on the engine operating states such as the intake air amount, the throttle valve opening amount, the accelerator pedal operation amount, the engine speed, the engine coolant temperature, etc. detected by the above-mentioned sensors 26 to 31, respectively. The delivery pipe 14 is provided with a pressure sensor 32, which detects the pressure of the fuel. The pressure sensor 32 transmits a signal indicating the detected pressure to the ECU 26. The ECU 26 controls the low-pressure feed pump 16 and the high-pressure pump 18 such that the pressure of the fuel (hereinafter, referred to as the “fuel pressure”) in the delivery pipe 14 substantially equals to a predetermined pressure. If the fuel pressure in the delivery pipe 14 exceeds the predetermined pressure, the relief valve 25 opens to permit the fuel to flow into the fuel discharge pipe 24, whereby the fuel pressure in the delivery pipe 14 is maintained at the predetermined pressure.

The injectors 13 will be described in more detail. In each injector 13, a valve body 42 is fixed to the front end portion of a hollow holder 41, as shown in FIGS. 1 to 5. An inner space 43 is formed in the valve body 42. The diameter of the valve body 42, which defines the inner space 43, decreases toward the front end of the valve body 42. A spherical space 44 is formed at the front end the valve body 42. The spherical space 44 is continuous with the inner space 43. An injection port 45, which provides communication between the spherical space 44 and the outside of the injector 13, is formed in the front end portion of the valve body 42. A hollow magnetic pipe 46 is fixed to the rear end portion of the holder 41. A cylindrical core 47 is fitted in the magnetic pipe 46. A cylindrical armature 48 is arranged on the front side of the core 47 with a predetermined distance kept therebetween such that the armature 48 is movable in the axial direction of the injector 13. The magnetic pipe 46 is formed by arranging a non-magnetic portion between an upper magnetic portion and a lower magnetic portion. The non-magnetic portion prevents a magnetic short-circuit between the upper magnetic portion and the lower magnetic portion. In the first embodiment of the invention, the holder 41, the valve body 42, the magnetic pipe 46, etc. form a fuel injection device.

A needle valve 49 serving as a fuel injection valve is a hollow body. The needle valve 49 is formed by integrally connecting a valve element 50 and a connection portion 51 to each other. The needle valve 49 is arranged inside the holder 41 and the valve body 42 so as to be movable in the axial direction of the injector 13. The rear end portion of the connection portion 51 is connected to the front end portion of the armature 48, and the front end portion of the valve element 50 is fitted in the inner space 43 formed in the valve body 42 with a predetermined distance kept between the outer face of the valve element 50 and the inner face of the valve body 42 in the radial direction of the holder 41. A seal portion 52 is arranged at the front end of the needle valve 49. A compression coil spring 54 is arranged between an adjust pipe 53 fitted in the core 47 and the armature 48. The compression coil spring 54 applies a force to the needle valve 49 via the armature 48 such that the needle valve 49 moves toward the front end of the valve body 42. The force is applied to the needle valve 49 such that the seal portion 52 contacts a valve seat portion 55 of the valve body 42.

A coil 57 is wound around the magnetic pipe 46 via a bobbin 56. A connector 58, made of resin molding, is formed around the coil 57. A yoke 59, made of magnetic material, is arranged around the connector 58. In the first embodiment of the invention, the compression coil spring 54, the core 47, the armature 48, the bobbin 56, the coil 57, the connector 58, the yoke 59, etc. form injection valve moving means. When electric power is supplied to the coil 57, an electromagnetic attraction force is generated in the core 47, and the armature 48 and the needle valve 49 are moved toward the rear of the injector 13 (upward in FIGS. 1 and 4) against the force of the compression coil spring 54, whereby the seal portion 52 moves away from the valve seat portion 55 of the valve body 42. In the first embodiment of the invention of the invention, when the seal portion 52 of the needle valve 49 closely contacts the valve seat portion 55 of the valve body 42, a distance S is kept between the core 47 and the armature 48. Accordingly, the needle valve 49 can move toward the rear of the injector 13 by the distance S. The distance S equals to the lift amount of the needle valve 49.

A fuel introduction pipe 60 is connected to the rear end portion of the magnetic pipe 46, and a relief pipe 61 is connected to the rear end portion of the core 47. A fuel filter 62 is arranged between the fuel introduction pipe 60 and the relief pipe 61.

According to the first embodiment of the invention, a fuel passage is formed in the injector 13. The fuel supplied from the outside of the injector 13 flows close by the injection port 45, and is then discharged to the outside of the injector 13 through the fuel passage. The needle valve 49 can block communication between the fuel passage and the injection port 45. Also, the needle valve 49 can permit communication between the fuel passage and the injection port such that part of the fuel flowing through the fuel passage is injected from the injection port 45.

The inner space formed in the hollow needle valve 49 is used as an inner passage 63. An outer passage 64 is formed around the needle valve 49. Two communication holes 65, which permit communication between the inner passage 63 and the outer passage 64, are formed in the front end portion of the needle valve 49. In the first embodiment of the invention, the two communication holes 65 are formed in the front end portion of the needle valve 49 at predetermined intervals in the circumferential direction. The space formed inside the cylindrical core 47 and the space formed inside the cylindrical armature 48 are used as center passages 66, 67, respectively. Notches 68, 69, which extend along the axial direction of the injector 13, are formed in the outer faces of the core 47 and the armature 48, whereby through-passages 70, 71 are formed, respectively. In addition, a fuel supply passage 72 is formed between the fuel introduction pipe 60 and the relief pipe 61, and a fuel discharge passage 73 is formed inside the relief pipe 61.

As shown in FIG. 6, the internal space within the delivery pipe 14 is partitioned into a first chamber 75 and a second chamber 76 by a partition wall 74. The second fuel supply pipe 19 is connected to the first chamber 75. The fuel discharge pipe 24 is connected to the second chamber 76. In the first embodiment of the invention, the pressure sensor 32 detects the fuel pressure in the first chamber 75. As shown in FIG. 1, the fuel supply passage 72 of the injector 13 is connected to the first chamber 75 of the delivery pipe 14. The fuel discharge passage 73 is connected to the second chamber 76.

The fuel is supplied from the first chamber 75 of the delivery pipe 14 to the fuel supply passage 72 of the injector 13. Then, the fuel flows through the fuel passage, and is discharged to the second chamber 76 of the delivery pipe 14. The fuel passage is formed of the through-passages 70 and 71 formed in the outer faces of the core 47 and the armature 48, the outer passage 64 formed around the needle valve 49, the communication holes 65 formed in the front end portion of the needle valve 49, the inner passage 63 formed inside the needle valve 49, the center passages 66, 67 formed inside the core 47 and the armature 48, and the fuel discharge passage 73.

The front end portion of the holder 41, which is a part of the fuel injection device, is fixed in a fitting hole 12a formed in the cylinder head 12. A gas seal (fitting seal) 77 is arranged between the outer face of the holder 41 and the inner wall that defines the fitting hole 12a. The fuel passage extends, beyond the gas seal 77, to a position close to the front end of the holder 41. The end portion of the fuel introduction pipe 60, which is the supply-side end portion of the fuel passage, is connected to a flange portion 33 of the delivery pipe 14 via an O-ring (a shaft seal) 78. The end portion of the relief valve 61, which is the discharge-side end portion of the fuel passage, is connected to the partition wall 74 via an O-ring (area seal) 79.

The operation of the fuel injection system for an internal combustion engine thus configured according to the first embodiment will be described below in detail. As shown in FIG. 6, the ECU 26 controls the low-pressure feed pump 16 and the high-pressure pump 18 based on the fuel pressure in the delivery pipe 14 detected by the pressure sensor 32 such that the fuel pressure in the delivery pipe 14 substantially equals to the predetermined pressure. The ECU 26 sets the fuel injection amount and the fuel injection time for each injector 13 based on the engine operating states such as the intake air amount, the throttle valve opening amount, the accelerator pedal operation amount, the engine speed, and the engine coolant temperature detected by the sensors 27 to 31, respectively. The ECU 26 thus controls the injectors 13.

When fuel injection is not performed, electric power is not supplied to the coil 57 of the injector 13. Accordingly, the seal portion 52 formed at the front end of the needle valve 49 closely contacts the valve seat portion 55 of the valve body 42 due to a force of the compression coil spring 54, whereby the needle valve 49 blocks communication between the outer passage 64 and the injection port 45, which form a part of the fuel passage. Therefore, when fuel injection is not performed, the fuel in the first chamber 75 of the delivery pipe 14 is supplied from the fuel supply passage 72 to the injector 13, flows through the through-passages 70, 71, the outer passage 64, the communication holes 65, the inner passage 63, the center passages 66, 67, and the fuel discharge passage 73, and is discharged to the second chamber 76 of the delivery pipe 14. Namely, the fuel flows close by the injection port 45 of the injector 13 while circulating in the fuel injection system. As a result, the front end portion of the holder 41 and the valve body 42 are cooled reliably.

On the other hand, when fuel injection is performed, electric power is supplied to the coil 57 of the injector 13. Accordingly, the needle valve 49 moves by the predetermined distance S due to the electromagnetic attraction force, and the seal portion 52 formed at the front end of the needle valve 49 moves away from the valve seat portion 55 of the valve body 42. As a result, communication between the outer passage 64 and the injection port 45 is permitted. Accordingly, the fuel in the first chamber 75 of the delivery pipe 14 is supplied from the fuel supply passage 72 to the injector 13, flows through the through-passages 70, 71, the outer passage 64, the communication holes 65, the inner passage 63, the center passages 66, 67, and the fuel discharge passage 73, and is discharged to the second chamber 76 of the delivery pipe 14. Also, part of the fuel flowing through the outer passage 64 is supplied to the spherical space 44, and the fuel in the spherical space 44 is injected from the injection port 45 to the combustion chamber 11. Namely, the fuel flows close to the injection port 45 of the injector 13, and only a predetermined amount of fuel having a predetermined pressure is injected from the injection port 45 to the combustion chamber 11. In addition, the rest of the fuel is discharged to the delivery pipe 14. As a result, the front end portion of the holder 41 and the valve body 42 are cooled reliably.

In the fuel injection system for an internal combustion engine according to the first embodiment of the invention, the base end portion of each injector 13 is connected to the delivery pipe 14. The fuel passage is formed in the injector 13. The fuel in the delivery pipe 14 flows close by the injection port 45 formed in the front end portion of the valve body 42, and then returns to the delivery pipe 14 through the fuel passage. Even if the needle valve 49 blocks communication between the fuel passage and the injection port 45, the fuel constantly flows close by the injection port 45 while circulating in the fuel injection system. Also, part of the fuel flowing through the fuel passage can be injected from the injection port 45 to the combustion chamber 11 by permitting communication between the fuel passage and the injection port 45.

When fuel injection is not performed, the needle valve 49 blocks communication between the fuel passage and the injection port 45. Accordingly, the fuel in the delivery pipe 14 flows close by the injection port 45 and then returns to the delivery pipe 14 through the fuel passage while circulating in the fuel injection system. Accordingly, the portion near the injection port 45 is reliably cooled by the fuel flowing through the fuel injection system. On the other hand, when fuel injection is performed, the needle valve 49 permits communication between the fuel passage and the injection port 45, whereby the fuel in the delivery pipe 14 flows close to the injection port 45 through the fuel passage, and only the predetermined amount of fuel having the predetermined pressure is injected from the injection port 45 to the combustion chamber 11. In addition, the rest of the fuel returns to the delivery pipe 14. Therefore, the portion near the injection port 45 is reliably cooled by the fuel circulating in the fuel injection system. This fuel passage can be used as both the passage, through which the fuel to be injected flows, and the passage, through which the fuel for cooling the portion near the injection port 45 flows. It is, therefore, possible to provide a more compact fuel injection system having more simple structure. Also, the portion near the injection port 45 can be cooled by causing the fuel to constantly flow through the fuel passage. As a result, it is possible to provide more efficient cooling in the injector 13.

The portion near the injection port 45 is cooled by causing the fuel to constantly flow through the fuel passage. Accordingly, even if the fuel remains near the injection port 45, the fuel is not baked, which reliably suppress accumulation of deposit on, for example, the inner face of the injection port 45. This reliably prevents fluctuation in the fuel injection amount and inefficient combustion. Also, air bubbles formed in the fuel in the fuel passage can be discharged by causing the fuel to constantly flow through the fuel passage. As a result, deterioration in the startability of the engine can be prevented, and idling operation can be performed more stably.

In the first embodiment of the invention, the injector 13 is applied to the direct injection engine 10 in which fuel is injected directly into the combustion chamber 11. The gas seal 77 is arranged between the outer face of the holder 41 and the inner wall that defines the fitting hole 12a formed in the cylinder head 12. The fuel passage extends, beyond the gas seal 77, close to the front end of the holder 41. Accordingly, even if the fuel remaining near the injection port 45 is baked by the combustion gas generated in the combustion chamber 11, the remaining fuel is cooled by the fuel flowing through the fuel passage during circulation in the fuel injection system. As a result, accumulation of the deposit on, for example, the inner face of the injection port 45, etc. is suppressed reliably.

In the fuel injection system for an internal combustion engine according to the first embodiment of the invention, the space formed in the hollow needle valve 49 is used as the inner passage 63. Also, the outer passage 64 is formed around the needle valve 49. The communication holes 65 formed in the front end portion of the needle valve 49 permit communication between the inner passage 63 and the outer passage 64. The inner passage 63, the outer passage 64, and the communication holes 65 are used as the fuel passage. Accordingly, the fuel passage can be formed without increasing the sizes of the holder 41, the valve body 42, etc. It is, therefore, possible to provide a more compact fuel injection system. In the first embodiment of the invention, the two communication holes 65 are formed in the front end portion of the needle valve 49 at predetermined intervals in the circumferential direction. Accordingly, unbalanced flow of the fuel from the outer passage 64 to the inner passage 63 is prevented. As a result, the portion near the injection port 45 can be cooled uniformly in the circumferential direction by the fuel flowing through the fuel passage while circulation in the fuel injection system.

In the fuel injection system for an internal combustion engine according to the first embodiment of the invention, because the space formed in the cylindrical core 47 and the space formed in the cylindrical armature 48 are used as the center passages 66, 67, respectively. In addition, the notches 68, 69, which are formed in the outer faces of the core 47 and the armature 48 and which extend along the axial direction of the injector 13, are used as the through-passages 70, 71, respectively. The center passages 66, 67 and the through-passages 70, 71 are used as the fuel passage. Accordingly, the fuel passage can be formed without increasing the sizes of the core 47, the armature 48, etc., which form the injection valve moving means. It is, therefore, possible to provide a more compact fuel injection system.

In the first embodiment of the invention, the fuel in the delivery pipe 14 is supplied from the fuel supply passage 72 to the injector 13, flows close to the injection port 45 through the trough-passages 70, 71 formed in the outer faces of the core 47 and the armature 48, and the outer passage 64 formed around the needle valve 49, flows through the communication holes 65, the inner passage 63 formed inside the needle valve 49, the center passages 66, 67 formed inside the core 47 and the armature 48, and the fuel discharge passage 73, and is discharged to the delivery pipe 14. Accordingly, the fuel receives heat from the holder 41 and the valve body 42 when approaching the injection port 45, and releases the heat when flowing away from the injection port 45 through the needle valve 49. Therefore, the difference in temperature between the holder 41/the valve body 42 and the needle valve 49 is reduced, which suppresses fluctuation in the fuel injection amount due to expansion of the injection port 45 and contraction of the needle valve 49.

The internal space within delivery pipe 14 is partitioned into the first chamber 75 and the second chamber 76 by the partition wall 74. The second fuel supply pipe 19, to which the high-pressure pump 18 is connected, is connected to the first chamber 75. The fuel discharge pipe 24, provided with the relief valve 25, is connected to the second chamber 76. With such structure, the fuel in the first chamber 75 is supplied to the fuel supply passage 72 formed in the injector 13, and returned from the fuel discharge passage 73 to the second chamber 76. The fuel is supplied to the first chamber 75 of the delivery pipe 14 by the high-pressure pump 18, and the discharged from the second chamber 76 by the relief valve 25, whereby a predetermined difference in the fuel pressure between the first chamber 75 and the second chamber 76 is maintained. As a result, the fuel reliably flows through the fuel passage while circulating in the fuel injection system. It is, therefore, possible to provide more efficient cooling in the injector 13.

In the injector 13, the end portion of the fuel introduction pipe 60 is connected to the flange portion 33 of the delivery pipe 14 via the O-ring 78 serving as the shaft seal, and the end portion of the relief pipe 61 is connected to the partition wall 74 via the O-ring 79 serving as the area seal. Accordingly, sealing is effectively provided between the inside of the delivery pipe 14 and the atmosphere. Also, using one of the O-rings as the shaft seal and the other O-ring as the area seal provides effective sealing even if the injector 13 is not fitted to the delivery pipe 14 appropriately.

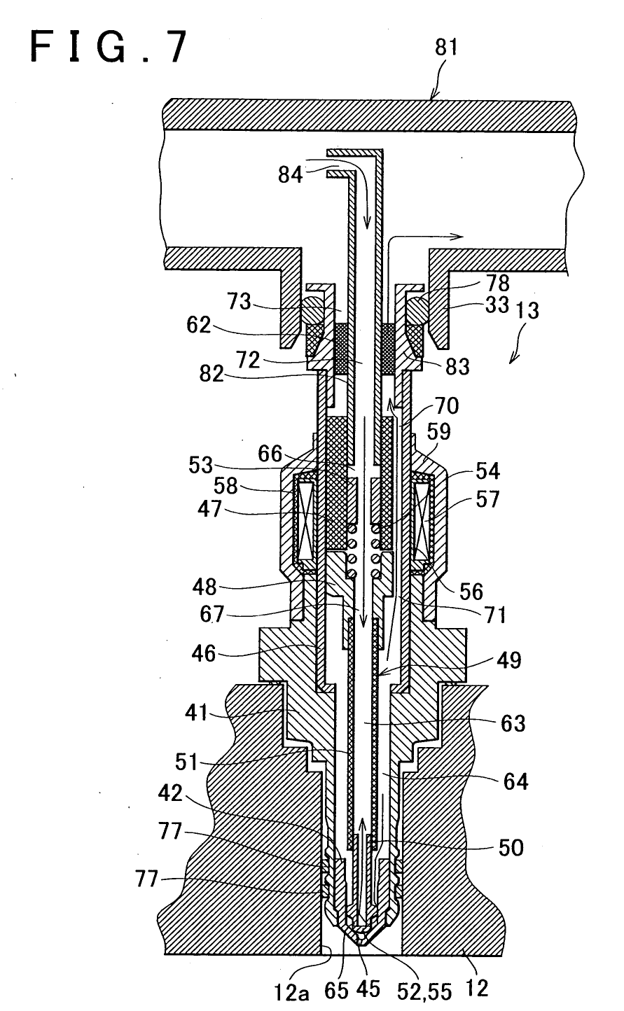

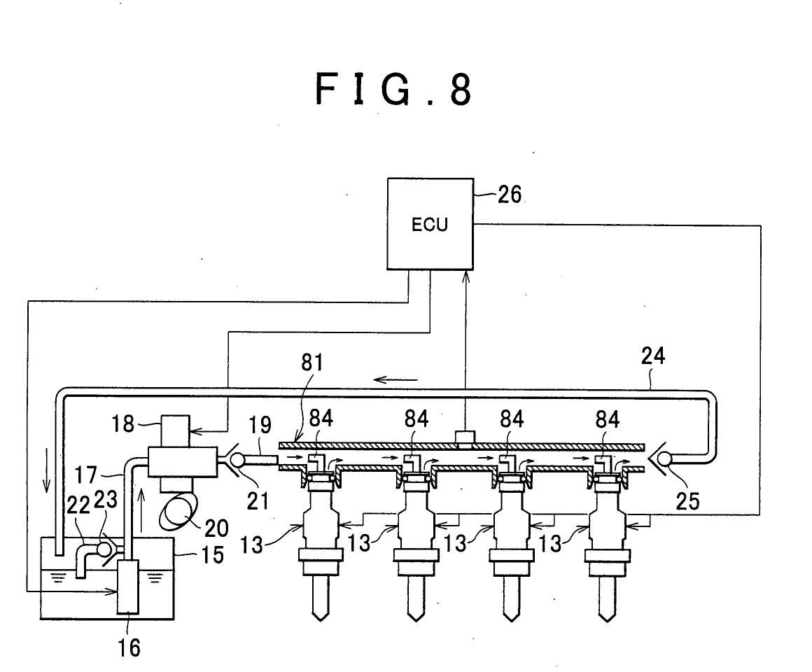

FIG. 7 is the cross sectional view showing an injector in a fuel injection system for an internal combustion engine according to a second embodiment of the invention. FIG. 8 is the view schematically showing the structure of the fuel injection system for an internal combustion engine according to the second embodiment of the invention. The components having the same functions as those in the first embodiment will be denoted by the same reference numerals, and will not be described below in detail.

In the fuel injection system for an internal combustion engine according to the second embodiment of the invention, the base end portions of the injectors 13 are connected to a delivery pipe 81, as shown in FIG. 8. The high-pressure pump 18 is connected to the first end portion of the delivery pipe 81 via the second fuel supply pipe 19. The base end portion of the fuel discharge pipe 24 is connected to the second end portion of the delivery pipe 81. The delivery pipe 81 is provided with the pressure sensor 32, which detects the fuel pressure in the delivery pipe 81. The pressure sensor 32 transmits a signal indicating the detected fuel pressure to the ECU 26.

Hereafter, the injector 13 will be described in detail. Because the basic structure of the injector 13 is the same as that in the first embodiment, only the differences with the injector 13 in the first embodiment will be described below. As shown in FIGS. 7 and 8, a fuel passage, through which the fuel supplied from the outside of the injector 13 flows close by the injection port 45 and is discharged to the outside of the injector 13, is formed in the injector 13. The needle valve 49 can block communication between the fuel passage and the injection port 45. Also, when the needle valve 49 moves away from the injection port 45, communication between the fuel passage and the injection port 45 is permitted such that part of the fuel flowing through the fuel passage is injected from the injection port 45.

The inner passage 63 is formed inside the needle valve 49. The outer passage 64 is formed around the needle valve 49. The two communication holes 65, which permit communication between the inner passage 63 and the outer passage 64, are formed in the front end portion of the needle valve 49. The center passages 66, 67 are formed inside the core 47 and the armature 48, and the through-passages 70, 71 are formed in the outer faces of the core 47 and the armature 48, respectively. In addition, the fuel supply passage 72 is formed in a fuel introduction pipe 82. The fuel discharge passage 73 is formed between the outer face of the fuel introduction pipe 82 and the inner face of a relief pipe 83.

The second fuel supply pipe 19 is connected to the first end portion of the delivery pipe 81, and the fuel discharge pipe 24 is connected to the second end portion of the delivery pipe 81. The fuel supply passage 72 and the fuel discharge passage 73, which are formed in the injector 13, are communicated with the delivery pipe 81. In the second embodiment of the invention, the end portion of the fuel introduction pipe 82, which is the fuel supply-side end portion, bends such that a fuel introduction port 84 formed at the end of the fuel introduction pipe 82 opens into the delivery pipe 81 so as to face the upstream side of the delivery pipe 81 in which the fuel flows.

The fuel passage is formed in the injector 13. Through the fuel passage, the fuel is supplied from the delivery pipe 81 to the fuel supply passage 72 through the fuel introduction port 84 of the injector 13, flows through the center passages 66, 67 formed inside the core 47 and the armature 48, the inner passage 63 formed inside the needle valve 49, the communication holes 65, the outer passage 64, the through-passages 70, 71 formed in the outer faces of the core 47 and the armature 48, and the fuel discharge passage 73, and is discharged to the delivery pipe 81.

In the fuel injection system for an internal combustion engine thus configured according to the second embodiment of the invention, when fuel injection is not performed, electric power is not supplied to the coil 57 of the injector 13. Accordingly, the seal portion 52 formed at the end of the needle valve 49 closely contacts the valve seat portion 55 of the valve body 42 due to a force of the compression coil spring 54, whereby the needle valve 49 blocks communication between the outer passage 64 and the injection port 45, which form part of the fuel passage. Therefore, the fuel in the delivery pipe 81 is supplied from the fuel supply passage 72 to the injector 13, flows through the center passages 66, 67, the inner passage 63, the communication holes 65, the outer passage 64, the through-passages 70, 71, and the fuel discharge passage 73, and is discharged to the delivery pipe 81. Namely, the fuel flows close by the injection port 45 of the injector 13. As a result, the front end portion of the holder 41 and the valve body 42 can be cooled reliably.

On the other hand, when fuel injection is performed, electric power is supplied to the coil 57 of the injector 13. Accordingly, the needle valve 49 is moved by the predetermined distance S due to an electromagnetic attraction force and the seal portion 52 formed at the end of the needle valve 49 moves away from the valve seat portion 55 of the valve body 42, whereby communication between the outer passage 64 and the injection port 45 is permitted. Therefore, the fuel in the delivery pipe 81 is supplied from the fuel supply passage 72 to the injector 13, flows through the center passages 66, 67, the inner passage 63, the communication holes 65, the outer passage 64, the through-passages 70, 71, and the fuel discharge passage 73, and is discharged to the delivery pipe 81. Also, part of the fuel flowing through the outer passage 64 is injected from the injection port 45 to the combustion chamber 11. Namely, the fuel flows close to the injection port 45 of the injector 13, and only a predetermined amount of fuel having a predetermined pressure is injected from the injection port 45 to the combustion chamber 11. In addition, the rest of the fuel is discharged to the delivery pipe 81. As a result, the front end portion of the holder 41 and the valve body 42 are cooled reliably.

In the fuel injection system for an internal combustion engine according to the second embodiment of the invention, the base end portion of each injector 13 is connected to the delivery pipe 81. The fuel passage, through which the fuel in the delivery pipe 81 flows close by the injection port 45 formed in the front end portion of the valve body 42 and then returned to the delivery pipe 14, is formed in the injector 13. Even if the needle valve 49 blocks communication between the fuel passage and the injection port 45, the fuel constantly flows close by the injection port 45 while circulating in the fuel injection system. Also, part of the fuel flowing through the fuel passage can be injected from the injection port 45 to the combustion chamber 11 by permitting communication between the fuel passage and the injection port 45.

Accordingly, the fuel in the delivery pipe 81 constantly flows close to the injection port 45 through the fuel passage. When fuel injection is performed, part of the fuel flowing through the fuel passage is injected from the injection port 45 to the combustion chamber 11, and the rest of the fuel is returned to the delivery pipe 81. As a result, the portion near the injection port 45 is reliably cooled by the fuel flowing through the fuel passage during circulation in the fuel injection system. This fuel passage can be used as both the passage, through which the fuel to be injected flows, and the passage, through which the fuel for cooling the portion near the injection port 45 flows. It is, therefore, possible to provide a more compact fuel injection system having more simple structure. Also, the portion near the injection port 45 can be cooled by causing the fuel to constantly flow through the fuel passage. As a result, it is possible to provide more efficient cooling in the injector 13.

The fuel introduction port 84 formed at the end of the fuel introduction pipe 82 of the injector 13 opens into the delivery pipe 81 so as to face the upstream side of the delivery pipe 81 in which the fuel flows. The dynamic pressure of the fuel flowing through the delivery pipe 81 is introduced to the fuel supply passage 72, and the static pressure is introduced to the fuel discharge passage 73, whereby a predetermined difference in the pressure in the delivery pipe 81 between the upstream side of the injector 13 and the downstream side of the injector 13 is maintained. Therefore, it is not necessary to form the delivery pipe 81 in a complicated shape. As a result, the fuel reliably flows through the fuel passage with a simple structure.

In the second embodiment of the invention, the fuel in the delivery pipe 81 is supplied from the fuel supply passage 72 to the injector 13, flows close to the injection port 45 through the center passages 66, 67 formed inside the core 47 and the armature 47, and the inner passage 63 formed in the needle valve 49, flows through the communication holes 65, the outer passage 64 formed around the needle valve 49, the through-passages 70, 71 formed in the outer faces of the core 47 and the armature 48, and the fuel discharge passage 73, and is discharged to the delivery pipe 81. Accordingly, the fuel having a low temperature flows close by the injection port 45. As a result, it is possible to provide more efficient cooling in the injector 13.

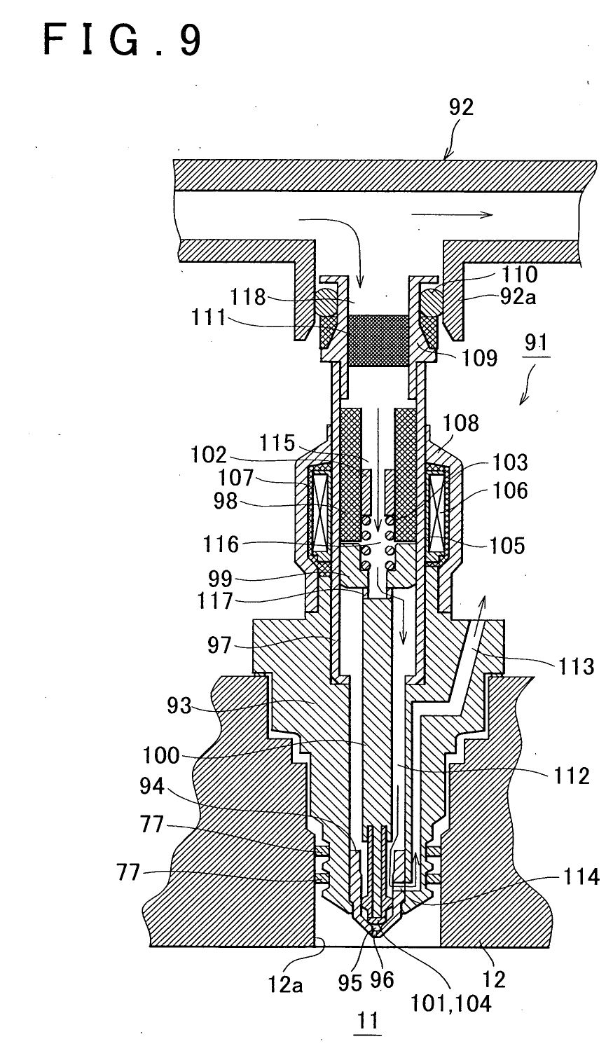

FIG. 9 is the cross sectional view showing an injector in a fuel injection system for an internal combustion engine according to a third embodiment of the invention. The components having the same functions as those in the embodiments described above will be denoted by the same reference numerals, and will not be described below in detail.

In the fuel injection system for an internal combustion engine according to the third embodiment of the invention, the base end portions of injectors 91 are connected to a delivery pipe 92, as shown in FIG. 9. A fuel supply pipe (not shown) is connected to the first end portion of the delivery pipe 92, and a fuel discharge pipe (not shown) is connected to the second end portion of the delivery pipe 92. In the injector 91, a valve body 94 is fixed to the front end portion of a holder 93, and a spherical space 95 and an injection port 96 are formed at the front end of the valve body 94. A magnetic pipe 97 is fixed to the rear end portion of the holder 93, and a core 98 is fixed in the magnetic pipe 97. An armature 99 is arranged on the front side of the core 98 so as to be movable in the axial direction of the injector 91. In the third embodiment of the invention, the holder 93, the valve body 94, the magnetic pipe 97, etc. form a fuel injection device.

A needle valve 100, serving as an injection valve, is arranged in the holder 93 and the valve body 94 so as to be movable in the axial direction of the injector 91. The rear end portion of the needle valve 100 is connected to the front end portion of the armature 99, and the front end portion of the needle valve 100 is fitted in the valve body 94 with a predetermined distance kept between the outer face of the needle valve 100 and the inner face of the valve body 94 in the radial direction. A seal portion 101 is formed at the front end portion of the needle valve 100. A compression coil spring 103 is arranged between an adjust pipe 102 fitted in the core 98 and the armature 99. A force is applied to the needle valve 100 by the compression coil spring 103 such that the seal portion 101 contacts a valve seat portion 104 of the valve body 94.

A coil 106 is wound around the magnetic pipe 97 via a bobbin 105. A connector 107 is formed around the coil 106. A yoke 108, made of magnetic material, is arranged around the connector 107. In the third embodiment of the invention, the compression coil spring 103, the core 98, the armature 99, the bobbin 105, the coil 106, the connector 107, the yoke 108, etc. form the injection valve moving means. Accordingly, when electric power is supplied to the coil 106, an electromagnetic attraction force is generated in the core 98. Due to the electromagnetic attraction force generated in the core 98, the armature 99 and the needle valve 100 are moved toward the rear of the injector 91 (upward in FIG. 9) against the force of the compression coil spring 103, whereby the seal portion 101 moves away from the valve seat portion 104 of the valve body 94.

A fuel introduction pipe 109 is connected to the rear end portion of the magnetic pipe 97. The end portion of the fuel introduction pipe 109 is connected to a flange portion 92a of the delivery pipe 92 via an O-ring 110. A fuel filter 111 is fitted in the fuel introduction pipe 109.

According to the third embodiment of the invention, a fuel passage, through which the fuel supplied from the outside of the injector 91 flows close to the injection port 96 and is discharged to the outside of the injector 91, is formed in the injector 91. The needle valve 100 can block communication between the fuel passage and the injection port 96. Also, the needle valve 100 can permit communication between the fuel passage and the injection port 96 such that part of the fuel flowing through the fuel passage is injected from the injection port 96.

An outer passage 112 is formed around the needle valve 100. A fuel discharge passage 113 is formed in the holder 93. A passage 114, which provides communication between the outer passage 112 and the fuel discharge passage 113, is formed in the front end portion of the valve body 94. Center passages 115, 116 are formed inside the core 98 and the armature 99, which form the injection valve moving means. A communication hole 117, which provides communication between the center passage 116 and the outer passage 112, is formed. In addition, a fuel supply passage 118, serving as a through-passage, is formed in the fuel introduction pipe 109. The end portion of the fuel discharge passage 113 is connected to the delivery pipe 92 or the fuel discharge pipe.

Through the fuel passage, the fuel is supplied from the delivery pipe 92 to the fuel supply passage 118 formed in the injector 91, flows through the center passages 115, 116 formed in the core 98 and the armature 99, the communication hole 117, the outer passages 112 formed around the needle valve 100, the passage 114, and the fuel discharge passage 113, and is discharged to the delivery pipe 92.

In the fuel injection system for an internal combustion engine thus configured according to the third embodiment of the invention, when fuel injection is not performed, electric power is not supplied to the coil 106 of the injector 91. Accordingly, the seal portion 101 formed at the end of the needle valve 100 closely contacts the valve seat portion 104 of the valve body 94 due to a force of the compression coil spring 103, whereby the needle valve 100 blocks communication between the outer passage 112 and the injection port 96, which form part of the fuel passage. Therefore, the fuel in the delivery pipe 92 is supplied from the fuel supply passage 118 to the injector 91, flows through the center passages 115, 116, the communication hole 117, the outer passage 112 formed around the needle valve 100, the passage 114, and the fuel discharge passage 113, and is discharged to the delivery pipe 92. Namely, the fuel flows close by the injection port 96 of the injector 91 while circulating in the fuel injection system. As a result, the front end portion of the holder 93 and the valve body 94 can be cooled reliably.

On the other hand, when fuel injection is performed, electric power is supplied to the coil 106 of the injector 91. Accordingly, the needle valve 100 is moved due to an electromagnetic attraction force and the seal portion 101 moves away from the valve seat portion 104, whereby communication between the outer passage 112 and the injection port 96, which form part of the fuel passage, is permitted. Therefore, the fuel in the delivery pipe 91 is supplied from the fuel supply passage 118 to the injector 91, flows through the center passages 115, 116, the communication hole 117, the outer passage 112 formed around the needle valve 100, the passage 114, and the fuel discharge passage 113, and is discharged to the delivery pipe 92. Also, part of the fuel flowing through the outer passage 112 is injected from the injection port 96 to the combustion chamber 11. Namely, the fuel flows close to the injection port 96 of the injector 91, and only a predetermined amount of fuel having a predetermined pressure is injected from the injection port 96 to the combustion chamber 11. In addition, the rest of the fuel is discharged to the delivery pipe 92. As a result, the front end portion of the holder 93 and the valve body 94 can be cooled reliably.

In the fuel injection system for an internal combustion engine according to the third embodiment of the invention, the base end portion of each injector 91 is connected to the delivery pipe 92. The fuel passage, through which the fuel in the delivery pipe 92 flows close by the injection port 96 formed in the front end portion of the valve body 94 and is returned to the delivery pipe 92, is formed in the injector 91. Even if the needle valve 100 blocks communication between the fuel passage and the injection port 96, the fuel constantly flows close by the injection port 96 while circulating in the fuel injection system. Also, part of the fuel flowing through the fuel passage can be injected from the injection port 96 to the combustion chamber 11 by permitting communication between the fuel passage and the injection port 96.

Accordingly, the fuel in the delivery pipe 92 constantly flows close to the injection port 96 through the fuel passage while circulating in the fuel injection system. When fuel injection is performed, part of the fuel flowing through the fuel passage is injected from the injection port 96 to the combustion chamber 11, and the rest of the fuel is returned to the delivery pipe 92. As a result, the portion near the injection port 96 can be reliably cooled by the fuel flowing through the fuel passage during circulation in the fuel injection system. This fuel passage can be used as both the passage, through which the fuel to be injected flows, and the passage, through which the fuel for cooling the portion near the injection port 96 flows. As a result, it is possible to provide a more compact fuel injection system having more simple structure. Also, the portion near the injection port 96 can be cooled by causing the fuel to constantly flow through the fuel passage. As a result, it is possible to provide more efficient cooling in the injector 91.

Also, the fuel in the delivery pipe 92 is supplied from the fuel supply passage 118 to the injector 91, approaches the injection port 96 through the center passages 115, 116 formed in the core 98 and the armature 99, and the outer passage 112 formed around the needle valve 100, flows through the passage 114, and the fuel discharge passage 113 formed in the holder 93, and is discharged to the delivery pipe 92. Accordingly, the fuel, which flows close by the injection port 96, is discharged from the side portion of the injector 91. As a result, it is possible to provide a more compact injector having a more simple fuel passage.

In each of the first, second, and third embodiments, the passage, through which the fuel approaches the injection port, and the passage, through which the fuel is returned to the delivery pipe, are formed by forming the inner passage inside the hollow needle valve and the outer passage around the needle valve, and forming the fuel discharge passage in the valve body. However, the structure is not limited to these. The inner passage or the outer passage of the needle valve may be partitioned into two passages by a partition plate. Alternatively, the fuel supply side and the fuel discharge side may be reversed.

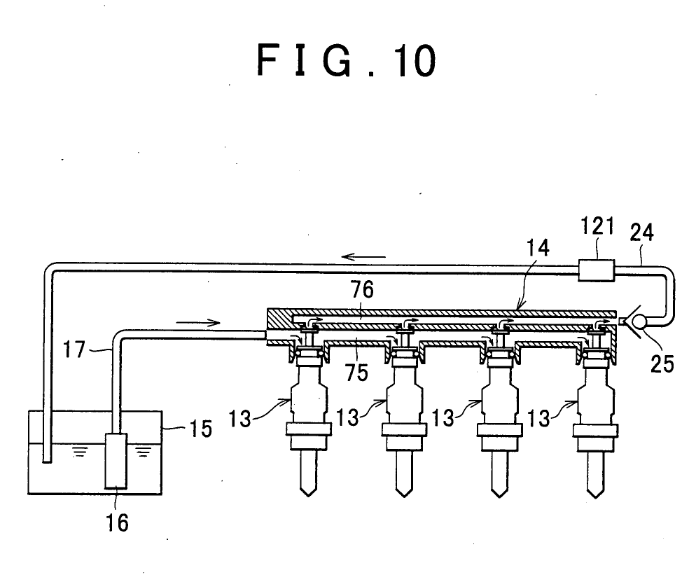

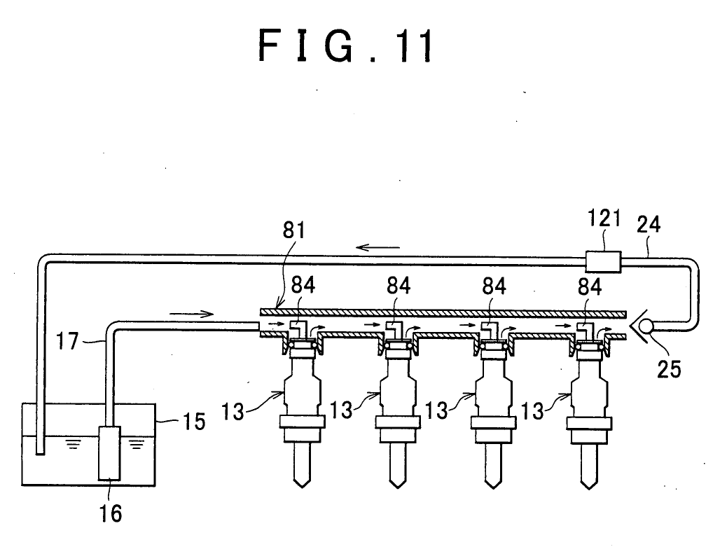

FIG. 10 is the view schematically showing the structure of a fuel injection system for an internal combustion engine according to a fourth embodiment of the invention. FIG. 11 is the view schematically showing a fuel injection system for an internal combustion engine according to a modified example of the fourth embodiment of the invention. The components having the same functions as those in the embodiments described above will be denoted by the same reference numerals, and will not be described below in detail.

In the fuel injection system for an internal combustion engine according to the fourth embodiment of the invention, the base end portions of the injectors 13 are connected to the delivery pipe 14, as shown in FIG. 10. The fuel in the delivery pipe 14 can be injected by each injector 13. The injector 13 and the delivery pipe 14 are the same as those in the first embodiment. The fuel tank 15 can store a predetermined amount of fuel. The low-pressure feed pump 16 is arranged in the fuel tank 15. The low-pressure feed pump 16 is connected to the first chamber 75 of the delivery pipe 14 via the fuel supply pipe 17. The base end portion of the fuel discharge pipe 24 is connected to the second chamber 76 of the delivery pipe 14. The fuel discharge pipe 24 is provided with a fuel cooler (fuel cooling means) 121 that air-cools the fuel flowing through the fuel discharge pipe 24.

The fuel in the fuel tank 15 is supplied to the delivery pipe 14 through the fuel supply pipe 17 by driving the low-pressure feed pump 16. The fuel in the delivery pipe 14 flows close to the injection port through the fuel passage formed in the injector 13. When fuel injection is performed, part of the fuel flowing through the fuel passage is injected from the injection port to the combustion chamber, and the rest of the fuel is returned to the delivery pipe 14, whereby the portion near the injection port is cooled by the fuel constantly flowing through the fuel passage during circulation in the fuel injection system. In the fourth embodiment of the invention, the amount of fuel flowing through the fuel passage formed in each injector 13 is adjusted by controlling the amount of fuel discharged by the low-pressure feed pump 16. The fuel, which is returned from the delivery pipe 14 to the fuel tank 15 through the fuel discharge passage 24, is cooled by the fuel cooler 121.

In the fuel injection system for an internal combustion engine according to the modified example of the fourth embodiment of the invention, the base end portions of each injectors 13 are connected to the delivery pipe 81, as shown in FIG. 11. The fuel in the delivery pipe 81 can be injected by each injector 13. The injector 13 and the delivery pipe 81 are the same as those in the second embodiment. The fuel tank 15 can store a predetermined amount of fuel. The low-pressure feed pump 16 is arranged in the fuel tank 15. The low-pressure feed pump 16 is connected to the first end portion of the delivery pipe 81 via the fuel supply pipe 17. The base end portion of the fuel discharge pipe 24 is connected to the second end portion of the delivery pipe 81. The fuel discharge pipe 24 is provided with the fuel cooler 121, which air-cools the fuel flowing through the fuel discharge pipe 24.

The fuel in the fuel tank 16 can be supplied to the delivery pipe 81 through the fuel supply pipe 17 by driving the low-pressure feed pump 16. The fuel in the delivery pipe 81 is introduced from the fuel introduction port 84 into each injector 13 by a dynamic pressure of the low-pressure feed pump 16, and flows close to the injection port through the fuel passage. When fuel injection is performed, part of the fuel flowing through the fuel passage is injected from the injection port to the combustion chamber, and the rest of the fuel is returned to the delivery pipe 81. As a result, the portion near the injection port is cooled by the fuel constantly flowing through the fuel passage during circulation in the fuel injection system. The amount of fuel flowing through the fuel passage formed in each injector 13 is adjusted by controlling the amount of fuel discharged by the low-pressure feed pump 16. Also, the fuel returned from the delivery pipe 81 to the fuel tank 15 through the fuel discharge passage 24 is cooled by the fuel cooler 121.

In the fuel injection system for an internal combustion engine according to the fourth embodiment of the invention, the base end portion of each injector 13 is connected to the delivery pipe 14, 81, and the low-pressure feed pump 16 is connected to the delivery pipe 14, 81 via the fuel supply pipe 17. In addition, the fuel discharge pipe 24 is connected to the delivery pipe 14, 81, and the fuel discharge pipe 24 is provided with the fuel cooler 121 which cools the fuel flowing through the fuel discharge pipe 24.

Because the fuel in the fuel tank 15 is supplied to the delivery pipe 14, 81 by driving the low-pressure feed pump 16, the fuel in the delivery pipe 14, 81 constantly flows close to the injection port through the fuel passage formed in each injector 13 while circulating in the fuel injection system, whereby the portion near the injection port is cooled. As a result, it is possible to provide more efficient cooling in the injector 13. Also, the amount of fuel flowing through the fuel passage formed in each injector 13 can be easily adjusted by controlling the amount of fuel discharged by the low-pressure feed pump 16. In addition, because the fuel, which is returned from the delivery pipe 14, 81 to the fuel tank 15 through the fuel discharge passage 24, is cooled by the fuel cooler 121, the temperature of the fuel circulating in the fuel injection system is reduced. As a result, it is possible to provide more efficient cooling in the injector 13. In addition, it is possible to suppress volatilization of the fuel.

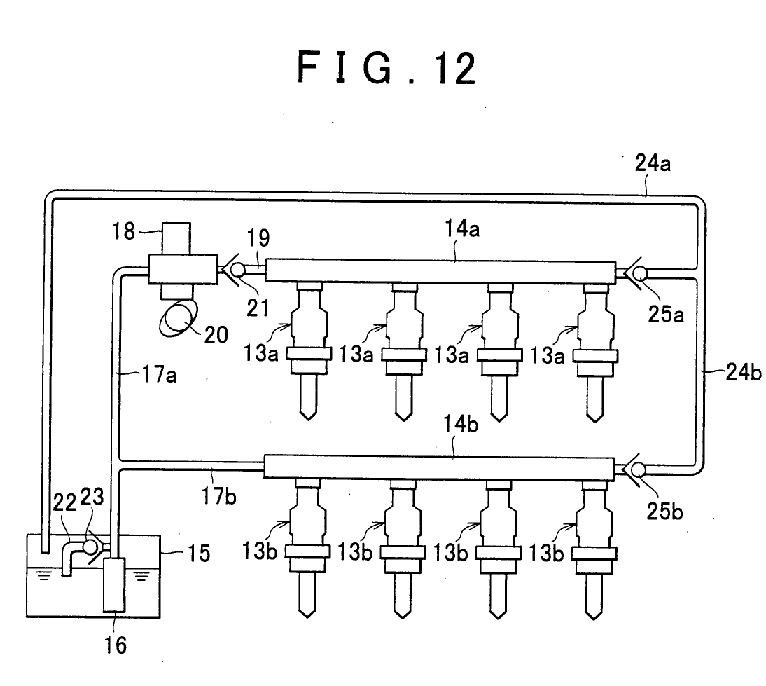

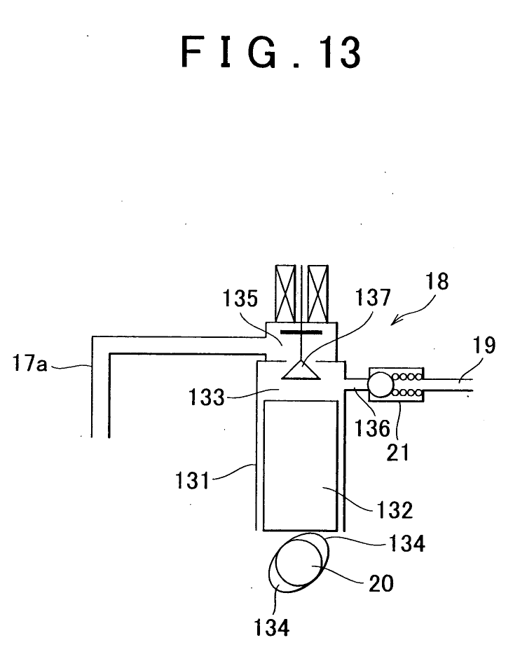

FIG. 12 is the view schematically showing the structure of a fuel injection system for an internal combustion engine according to a fifth embodiment of the invention. FIG. 13 is the view schematically showing the high-pressure pump. The components having the same functions as those in the embodiments described above will be denoted by the same reference numerals, and will not be described below in detail.

In the fuel injection system for an internal combustion engine according to the fifth embodiment of the invention, the base end portions of high-pressure injectors 13a are connected to a delivery pipe 14a, and the base end portions of low-pressure injectors 13b are connected to a delivery pipe 14b, as shown in FIG. 12. Each high-pressure injector injects high-pressure fuel in the delivery pipe 14a into the combustion chamber. Each low-pressure injector 13b injects low-pressure fuel in the delivery pipe 14b to the intake port.

The fuel tank 15 can store a predetermined amount of fuel. The low-pressure feed pump 16 is arranged in the fuel tank 15. The high-pressure pump 18 is connected to the low-pressure pump 16 via a first fuel supply pipe 17a. The high-pressure pump 18 is connected to the first end portion of the delivery pipe 14a via the second fuel supply pipe 19. The high-pressure pump 18 can be driven by the camshaft 20. The second fuel supply pipe 19 is provided with the check valve 21. The return pipe 22, through which fuel is sent back to the fuel tank 15, is connected to the first fuel supply pipe 17a. The return pipe 22 is provided with the check valve 23. The base end portion of a first fuel discharge pipe 24a is connected to the second end portion of the delivery pipe 14a. The other end portion of the first fuel discharge pipe 24a is connected to the fuel tank 16. The first fuel discharge pipe 24a is provided with a relief valve 25a. A third fuel supply pipe 17b, which branches off from the first fuel supply pipe 17a, is connected to the first end portion of the delivery pipe 14b. The base end portion of a second fuel discharge pipe 24b is connected to the second end portion of the delivery pipe 14b. The other end portion of the second fuel discharge pipe 24b is connected to the first fuel discharge pipe 24a. The second fuel discharge pipe 24b is provided with a relief valve 25b.

In the high-pressure pump 18, a plunger 132 is movably supported in a casing 131, as shown in FIG. 13. Also, a pressure chamber 133, in which the fuel is pressurized, is formed in the casing 131. A force is applied to the plunger 132 by a spring (not shown) such that volume of the pressure chamber 133 increases. The plunger 132 can reduce the volume of the pressure chamber 133 by being pressed by a cam 134 provided onto the camshaft 20. An intake port 135, which is communicated with the first fuel supply pipe 17a and through which low-pressure fuel is taken in the pressure chamber 133, is formed in the upper portion of the casing 131. Also, a discharge port 136, through which the pressurized fuel is discharged to the second fuel supply pipe 19, is formed in the upper portion of the casing 131. In addition, a metering valve 137, which opens/closes the intake port 135, is formed at the upper portion of the casing 131. The metering valve 137 is an electromagnetic spill valve. The metering valve 137 blocks the intake port 135, when electric power is supplied to the metering valve 137.

When the cam shaft 20 rotates and the plunger 132 is moved downward by the cam 134, the metering valve 137 opens the intake port 135. When the intake port 135 is open, the low-pressure fuel is taken in the pressure chamber 133. When the camshaft 20 further rotates and the plunger 132 is moved upward by the cam 134, the metering valve 137 blocks the intake port 135. When the intake port 135 is blocked, the low-pressure fuel in the pressure chamber 133 is pressurized such that the pressure thereof substantially equals to a predetermined pressure, and sent from the discharge port 136.

In the fuel injection system for an internal combustion engine thus configured according to the fifth embodiment of the invention, the high-pressure fuel is supplied to the delivery pipe 14a by driving the low-pressure feed pump 16 and the high-pressure pump 18. The fuel in the delivery pipe 14a flows close to the injection port through the fuel passage formed in each high-pressure injector 13a while circulating in the fuel injection system. When fuel injection is performed, part of the high-pressure fuel flowing through the fuel passage is injected from the injection port to the combustion chamber, and the rest of the fuel is returned to the delivery pipe 14a. Thus, the portion near the injection port is cooled by the fuel constantly flowing through the fuel passage during circulation in the fuel injection system. The low-pressure fuel is supplied to the delivery pipe 14b by driving the low-pressure feed pump 16. The fuel in the delivery pipe 14b flows close to the injection port through the fuel passage formed in each low-pressure injector 13b while circulating in the fuel injection system. When fuel injection is performed, part of the low-pressure fuel flowing through the fuel passage is injected from the injection port to the intake port, and the rest of the fuel is returned to the delivery pipe 14b. Thus, the portion near the injection port is cooled by the fuel constantly flowing through the fuel passage during circulation in the fuel injection system.

In the fifth embodiment of the invention, whether the fuel is injected from the high-pressure injector 13a into the combustion chamber or the fuel is injected from the low-pressure injector 13b to the intake port can be selected based on the operating state of the vehicle. For example, when the engine is started while the temperature thereof is high, the low-pressure fuel is supplied to the delivery pipes 14a, 14b by stopping the high-pressure pump 18 and driving the low-pressure feed pump 16. The fuel in the delivery pipes 14a, 14b flows close to the injection ports through the fuel passages formed in the injectors 13a, 13b, whereby the end portions of the injectors 13a, 13b are cooled. Part of the low-pressure fuel flowing through the fuel passage formed in each low-pressure injector 14b is injected from the injection port to the intake port. In the fifth embodiment of the invention, even if the high-pressure pump 18 is stopped, the low-pressure fuel can be supplied to the high-pressure injector 13a by opening the metering valve 137.

When the engine runs at high load and high speed, fuel injection to the combustion chamber by the high-pressure injector 13a is stopped, and fuel injection to the intake port by the low-pressure injector 13b is performed. Even in this case, as described above, the low-pressure fuel is caused to flow close to the injection ports from the delivery pipes 14a, 14b through the fuel passages formed in the injectors 13a, 13b by stopping the high-pressure pump 18 and driving the low-pressure feed pump 16. Thus, the end portions of the injectors 13a, 13b are cooled. In the fifth embodiment of the invention, the amount of fuel flowing through the fuel passage formed in each of the injectors 13a, 13b is adjusted by controlling the amount of fuel discharged by the low-pressure feed pump 16.

The fuel injection system for an internal combustion engine according to the fifth embodiment of the invention is provided with a high-pressure fuel injection system and a low-pressure fuel injection system. The high-pressure injection system includes the high-pressure pump 18, the high-pressure injectors 13a, and the delivery pipe 14a. The low-pressure fuel injection system includes the low-pressure feed pump 16, the low-pressure injectors 13b, and the delivery pipe 14b. When the high-pressure fuel injection system is stopped, the high-pressure pump 18 is stopped and the low-pressure feed pump 16 is driven. Thus, the low-pressure fuel flows close to the injection ports from the delivery pipes 14a, 14b through the fuel passages formed in the injectors 13a, 13b while circulating in the fuel injection system. As a result, the end portions of the injectors 13a, 13b are cooled.

Because the fuel constantly flows close to the injection ports through the fuel passages formed in the injectors 13a, 13b while circulating in the fuel injection system, the portions near the injection ports are reliably cooled. As a result, it is possible to provide more efficient cooling in the injectors 13a, 13b. When the high-pressure fuel injection system is stopped, the end portions of the high-pressure injectors 13a are heated by the combustion gas in the combustion chambers. Even in such a case, the end portions of the high-pressure injectors 13a are appropriately cooled.

Also, the amount of fuel flowing through the fuel passages formed in the injectors 13a, 13b while circulating in the fuel injection system are easily adjusted by controlling the amount of fuel discharged by the low-pressure feed pump 16.

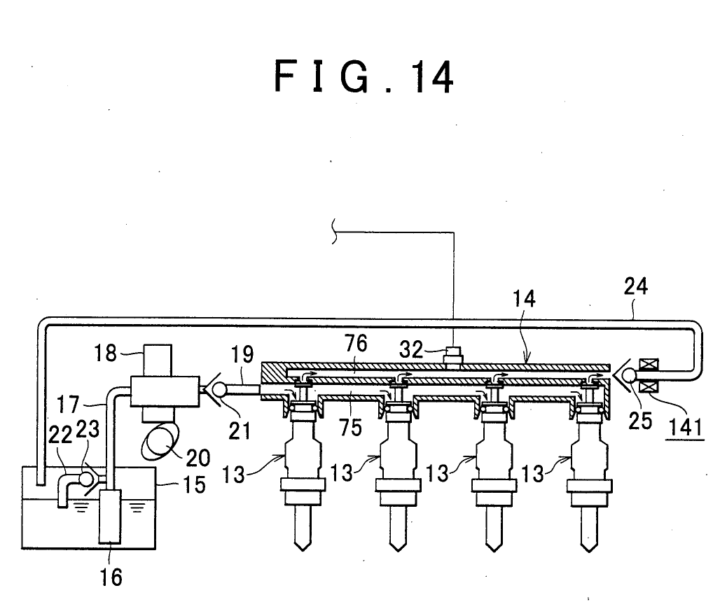

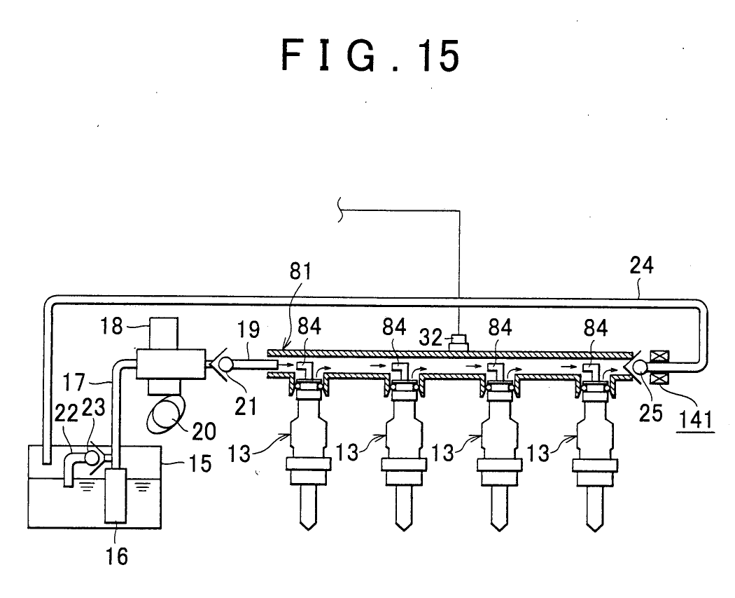

FIG. 14 is the view schematically showing the structure of a fuel injection system for an internal combustion engine according to a sixth embodiment of the invention. FIG. 15 is the view schematically showing the structure of a fuel injection system for an internal combustion engine according to a modified example of the sixth embodiment. The components having the same functions as those in the embodiments described above will be denoted by the same reference numerals, and will not be described below in detail.

In the fuel injection system for an internal combustion engine according to the sixth embodiment of the invention, the base end portions of the injectors 13 are connected to the delivery pipe 14, as shown in FIG. 14. Each injector 13 injects the fuel present in the delivery pipe 14. The injector 13 and the delivery pipe 14 are the same as those in the first embodiment described above. The low-pressure feed pump 16 is arranged in the fuel tank 15. The low-pressure feed pump 16 is connected to the high-pressure pump 18 via the first fuel supply pipe 17. The high-pressure pump 18 is connected to the first chamber 75 of the delivery pipe 14 via the second fuel supply pipe 19. The base end portion of the fuel discharge pipe 24 is connected to the second chamber 76 of the delivery pipe 14. The fuel discharge pipe 24 is provided with the electromagnetic relief valve 141.

The fuel in the fuel tank 16 is supplied to the delivery pipe 14 through the fuel supply pipes 17, 19 by driving the low-pressure feed pump 16 and the high-pressure pump 18. Then, the fuel in the delivery pipe 14 is caused to flow close to the injection port through the fuel passage formed in each injector 13. When fuel injection is performed, part of the fuel flowing through the fuel passage is injected from the injection port into the combustion chamber, and the rest of the fuel is returned to the delivery pipe 14, whereby the portion near the injection port is cooled by the fuel constantly flowing through the fuel passage during circulation in the fuel injection system. At this time, the amount of fuel flowing through the fuel passage formed in each injector 13 is adjusted by controlling the relief pressure of the electromagnetic relief valve 141 to change the fuel pressure in the delivery pipe 14.

In the fuel injection system for an internal combustion engine according to the modified example of the sixth embodiment of the invention, the base end portions of the injectors 13 are connected to the delivery pipe 81, as shown in FIG. 15. Each injector 13 injects the fuel present in the delivery pipe 81. The injector 13 and the delivery pipe 81 are the same as those in the second embodiment. The low-pressure feed pump 16 is arranged in the fuel tank 15. The low-pressure feed pump 16 is connected to the high-pressure pump 18 via the first fuel supply pipe 17. The high-pressure pump 18 is connected to the first end portion of the delivery pipe 81 via the second fuel supply pipe 19. The base end portion of the fuel discharge pipe 24 is connected to the second end portion of the delivery pipe 81. The fuel discharge pipe 24 is provided with the electromagnetic relief valve 141.

The fuel in the fuel tank 16 is supplied to the delivery pipe 81 through the fuel supply pipes 17, 19 by driving the low-pressure feed pump 16 and the high-pressure pump 18. Then, the fuel in the delivery pipe 81 is caused to flow to close to the injection port through the fuel passage formed in each injector 13. When fuel is injected, part of the fuel flowing through the fuel passage is injected from the injection port to the combustion chamber and the rest of the fuel is returned to the delivery pipe 81. Thus, the portion near the injection port is cooled by the fuel constantly flowing through the fuel passage during circulation in the fuel injection system. At this time, the amount of fuel flowing through the fuel passage formed in each injector 13 is adjusted by controlling the relief pressure of the electromagnetic relief valve 141 to change the fuel pressure in the delivery pipe 81.

In the fuel injection system for an internal combustion engine according to the sixth embodiment of the invention, the base end portions of the injectors 13 are connected to the delivery pipe 14, 81. The low-pressure feed pump 16 and the high-pressure pump 18 are connected to the delivery pipe 14, 81 via the fuel supply pipes 17, 19. The fuel discharge pipe 24 is connected to the delivery pipe 14, 81. The fuel discharge pipe 24 is provided with the electromagnetic relief valve 141.

Because the fuel is supplied to the delivery pipe 14, 81 by driving the low-pressure feed pump 16 and the high-pressure pump 18, the fuel in the delivery pipe 14, 81 is caused to constantly flow close to the injection port through the fuel passage formed in each injector 13. Thus, the portion near the injection port can be cooled. As a result, it is possible to provide more efficient cooling in the injector 13. Also, the amount of fuel flowing through the fuel passage formed in each injector 13 during circulation in the fuel injection system is easily adjusted by controlling the relief pressure of the electromagnetic relief valve 141 to change the fuel pressure in the delivery pipe 14, 81.

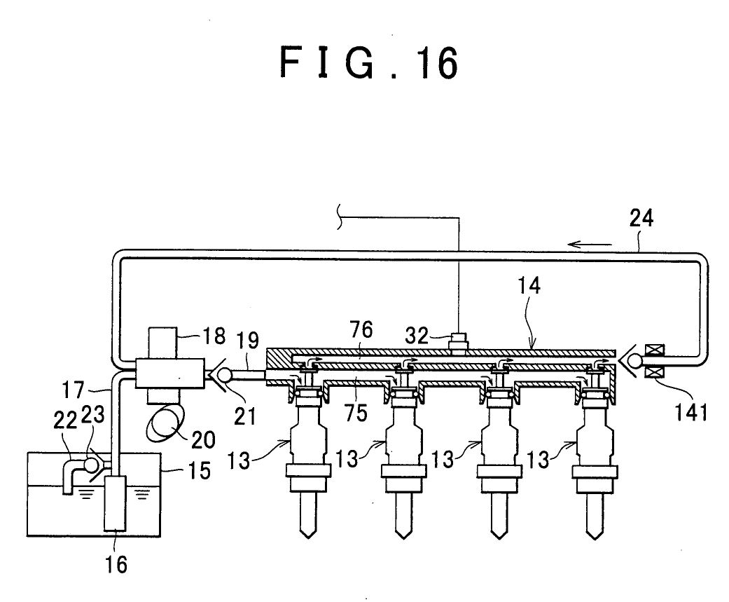

FIG. 16 is the view schematically showing the structure of a fuel injection system for an internal combustion engine according to a seventh embodiment of the invention. FIG. 17 is the view schematically showing the structure of a fuel injection system for an internal combustion engine according to a modified example of the seventh embodiment of the invention. The components having the same functions as those in the embodiments described above will be denoted by the same reference numerals, and will not be described below in detail.

In the fuel injection system for an internal combustion engine according to the seventh embodiment of the invention, the base end portions of the injectors 13 are connected to the delivery pipe 14, as shown in FIG. 16. Each injector 13 injects the fuel present in the delivery pipe 14. The injector 13 and the delivery pipe 14 are the same as those in the first embodiment of the invention. The low-pressure feed pump 16 is arranged in the fuel tank 15. The low-pressure feed pump 16 is connected to the high-pressure pump 18 via the first fuel supply pipe 17. The high-pressure pump 18 is connected to the first chamber 75 of the delivery pipe 14 via the second fuel supply pipe 19. The base end portion of the fuel discharge pipe 24 is connected to the second chamber 76 of the delivery pipe 14. The other end portion of the fuel discharge pipe 24 is connected to the intake port of the high-pressure pump 18. The fuel discharge pipe 24 is provided with the electromagnetic relief valve 141.

When the low-pressure feed pump 16 and the high-pressure pump 18 are driven, the fuel in the fuel tank 15 is supplied to the delivery pipe 14 through the fuel supply pipes 17, 19. Thus, the fuel in the delivery pipe is caused to flow close to the injection port through the fuel passage formed in each injector 13. When fuel injection is performed, part of the fuel flowing through the fuel passage is injected from the injection port to the combustion chamber, and the rest of the fuel is returned to the delivery pipe 14. Thus, the portion near the injection port is cooled by the fuel constantly flowing through the fuel passage during circulation in the fuel injection system. Then, the fuel in the delivery pipe 14 is discharged to the fuel discharge pipe 24 when the electromagnetic relief valve 141 is open, and returned to the intake port of the high-pressure pump 18 through the fuel discharge pipe 24.

In the fuel injection system for an internal combustion engine according to the modified example of the seventh embodiment of the invention, the base end portion of the fuel discharge pipe 24 is connected to the second chamber 76 of the delivery pipe 14, and the other end portion of the fuel discharge pipe 24 is connected to the intake port of the low-pressure feed pump 16. Accordingly, the fuel in the delivery pipe 14 is discharged to the fuel discharge pipe 24 when the electromagnetic relief valve 141 is open, and returned to the intake port of the low-pressure feed pump 16 through the fuel discharge pipe 24.

In the fuel injection system for an internal combustion engine according to the seventh embodiment of the invention, the fuel discharge pipe 24 is connected to the delivery pipe 14, and the fuel discharge pipe 24 is connected to the intake port of the high-pressure pump 18 or the low-pressure feed pump 16. Accordingly, the fuel in the delivery pipe 14 is discharged to the fuel discharge pipe 24, and returned to the intake ports of the pumps 18, 16 through the fuel discharge pipe 24. The amount of fuel volatilized in the fuel tank 15 is reduced by reducing the amount of fuel returned to the fuel tank 15. Also, when the fuel discharge pipe 24 is connected to the intake port of the high-pressure pump 18, the length of the route through which the fuel is returned to the fuel tank 15 is reduced. Accordingly, the difference in the temperature of the fuel circulated in the fuel injection system is reduced. As a result, the portion near the injection port can be more appropriately cooled.

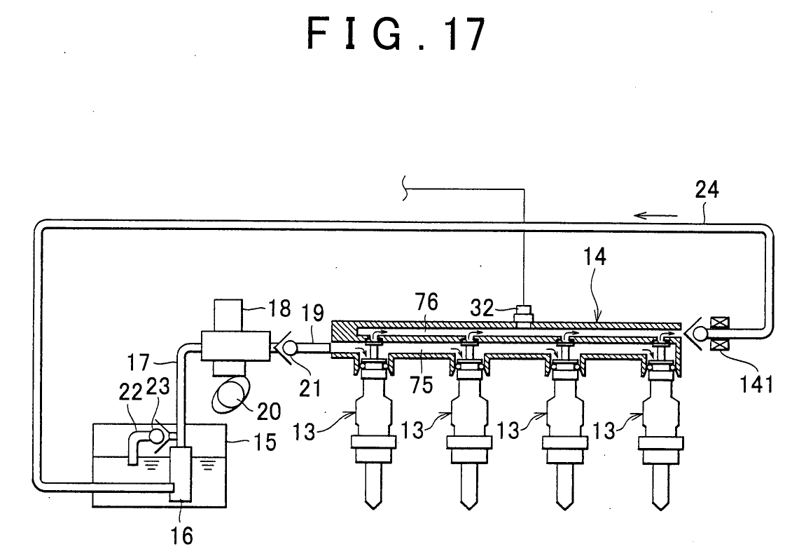

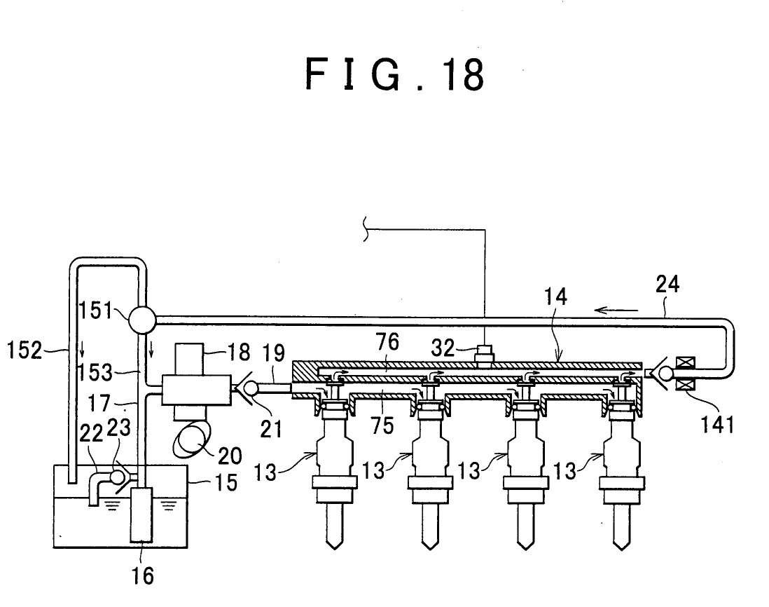

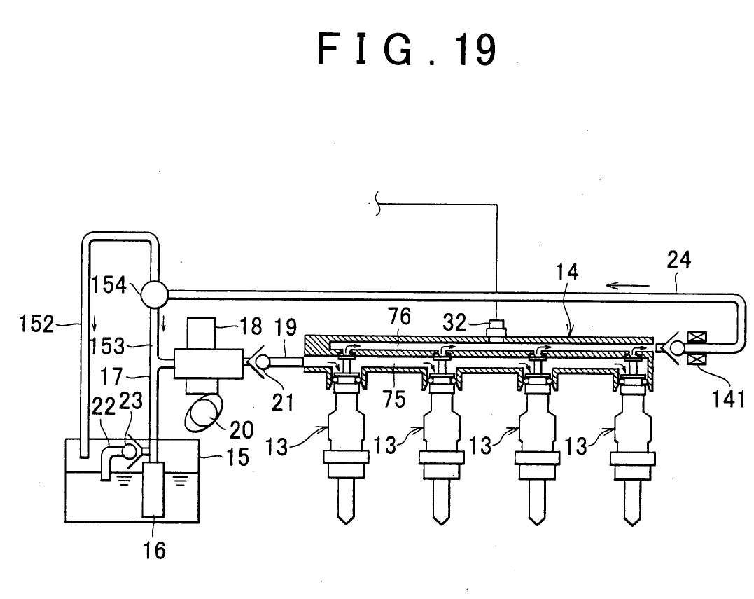

FIG. 18 is the view schematically showing the structure of a fuel injection system for an internal combustion engine according to an eighth embodiment of the invention. FIG. 19 is the view schematically showing the structure of a fuel injection system for an internal combustion engine according to a modified example of the eighth embodiment of the invention. The components having the same functions as those in the embodiments described above will be denoted by the same reference numerals, and will not be described below in detail.

In the fuel injection system for an internal combustion engine according to the eighth embodiment of the invention, the base end portions of the injectors 13 are connected to the delivery pipe 14, as shown in FIG. 18. Each injector 13 injects the fuel present in the delivery pipe 14. The injector 13 and the delivery pipe 14 are the same as those in the first embodiment of the invention. The low-pressure feed pump 16 is arranged in the fuel tank 15. The low-pressure feed pump 16 is connected to the high-pressure pump 18 via the first fuel supply pipe 17. The high-pressure pump 18 is connected to the first chamber 75 of the delivery pipe 14 via the second fuel supply pipe 19. The base end portion of the fuel discharge pipe 24 is connected to the second chamber 76 of the delivery pipe 14. The other end portion of the fuel discharge pipe 24 branches off into two branch passages 152, 153 at a switching valve 151. The first branch passage 152 is connected to the fuel tank 15. The second branch passage 153 is connected to the intake port of the high-pressure pump 18.

When the low-pressure feed pump 16 and the high-pressure pump 18 are driven, the fuel in the fuel tank 15 is supplied to the delivery pipe 14 through the fuel supply pipes 17, 19. Then, the fuel in the delivery pipe 14 is caused to flow close to the injection port through the fuel passage formed in each injector 13 during circulation in the fuel injection system. When fuel injection is performed, part of the fuel flowing through the fuel passage is injected from the injection port to the combustion chamber, and the rest of the fuel is returned to the delivery pipe 14. Thus, the portion near the injection port is cooled by the fuel constantly flowing through the fuel passage during circulation in the fuel injection system. The fuel in the delivery pipe 14 is discharge to the fuel discharge pipe 24 when the electromagnetic relief valve 141 is open, and then returned to the intake port of the fuel tank 15 or the high-pressure pump 18 through the fuel discharge pipe 24.

When the temperature of the engine coolant is low, for example, when the engine is started while it is cold, the switching valve 151 permits communication between the fuel discharge pipe 24 and the first branch passage 152, whereby the fuel is returned to the fuel tank 15 to increase the temperature of the fuel. Thus, the combustion efficiency improves. On the other hand, when the temperature of the engine coolant is high, for example, when the engine runs at high load, the switching valve 151 permits communication between the fuel discharge pipe 24 and the second branch passage 153, whereby the fuel is returned to the intake port of the high-pressure pump 18 to reduce the amount of fuel returned to the fuel tank 15. Thus, the amount of fuel volatilized in the fuel tank 15 is reduced.

In the fuel injection system for an internal combustion engine according to the modified example of the eighth embodiment of the invention, the end portion of the fuel discharge pipe 24 branches off into the two branch passages 152, 153 at a flow-amount adjustment valve 154, as shown in FIG. 19. The first branch passage 152 is connected to the fuel tank 15. The second branch passage 153 is connected to the intake port of the high-pressure pump 18. Accordingly, when the temperature of the engine coolant is low, the opening amount of the flow-amount adjustment valve 154 is adjusted to return a greater amount of fuel to the fuel tank 15 to increase the temperature of the fuel. Thus, the combustion efficiency improves. On the other hand, when the temperature of the engine coolant is high, the opening amount of the flow-amount adjustment valve 154 is adjusted to return a greater amount of fuel to the intake port of the high-pressure pump 18 to reduce the amount of fuel returned to the fuel tank 15. Thus, the amount of fuel volatilized in the fuel tank 15 is reduced. Various controls can be easily performed by adjusting the opening amount of the flow-amount adjustment valve 154 such that the temperature of the fuel flowing through the delivery pipe 14 is uniform.

In the fuel injection system for an internal combustion engine according to the eighth embodiment of the invention, the fuel discharge pipe 24 is connected to the delivery pipe 14. The fuel discharge pipe 24 branches off into the two branch passages 152, 153 at the switching valve 152 or the flow-amount adjustment valve 154. The first branch passage 152 is connected to the fuel tank 15. The second branch passage 153 is connected to the intake port of the high-pressure pump 18. Accordingly, the branch passage communicated with the fuel discharge pipe 24 is changed between the first branch passage 152 and the second branch passage 153 by the switching valve 151 or the opening amount of the flow-amount adjustment valve 154 is adjusted based on the operating state of the engine, whereby the appropriate combustion temperature is maintained to improve the combustion efficiency, and the amount of fuel volatilized in the fuel tank 15 is reduced.

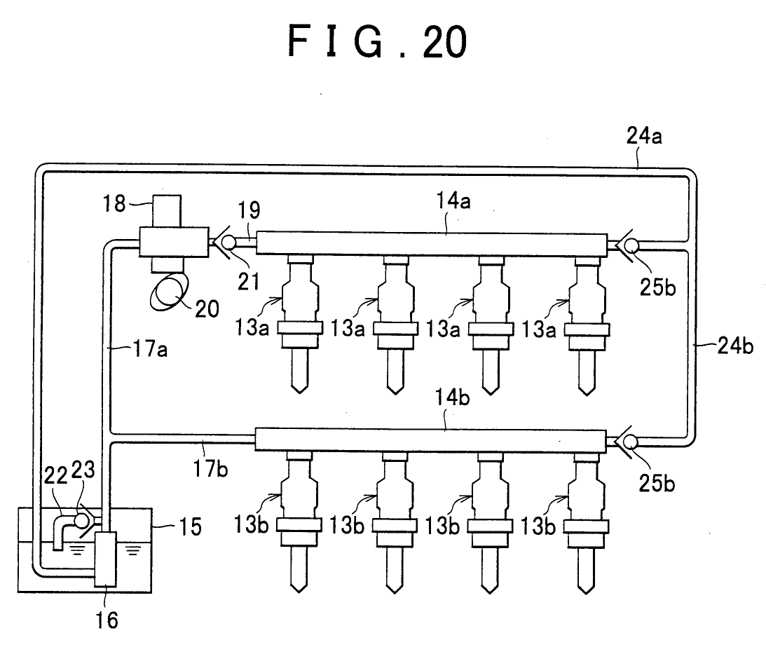

FIG. 20 is the view schematically showing the structure of a fuel injection system for an internal combustion engine according to a ninth embodiment of the invention. The components having the same functions as those in the embodiments described above will be denoted by the same reference numerals, and will not be described below in detail.

In the fuel injection system for an internal combustion engine according to the ninth embodiment of the invention, the base end portions of the high-pressure injectors 13a are connected to the delivery pipe 14a, and the base end portions of the low-pressure injectors 13b are connected to the delivery pipe 14b, as shown in FIG. 20. Each high-pressure injector 13a injects the high-pressure fuel in the delivery pipe 14a into the combustion chamber. Each low-pressure injector 13b injects the low-pressure fuel in the delivery pipe 14b to the intake port.

The low-pressure feed pump 16 arranged in the fuel tank 15 is connected to the high-pressure pump 18 via the first fuel supply pipe 17a. The high-pressure pump 18 is connected to the delivery pipe 14a via the second fuel supply pipe 19. The delivery pipe 14a is connected to the intake port of the low-pressure feed pump 16 via the first fuel discharge pipe 24a. The third fuel supply pipe 17b, which branches off from the first fuel supply pipe 17a, is connected to the delivery pipe 14b. The delivery pipe 14b is connected to the first fuel discharge pipe 24a via the second fuel discharge pipe 24b.

When the engine is started while the temperature thereof is high, the low-pressure fuel is supplied to the delivery pipes 14a, 14b by stopping the high-pressure pump 18 and driving the low-pressure feed pump 16. Then, the fuel in the delivery pipe 14a and the fuel in the delivery pipe 14b are caused to flow close to the injection ports through the fuel passages formed in the injectors 13a, 13b during circulation in the fuel injection system, respectively. Thus, the end portions of the injectors 13a, 13b are cooled. Also, part of the low-pressure fuel flowing through the fuel passage formed in the low-pressure injector 13b is injected from the injection port to the intake port. In the ninth embodiment of the invention, the amount of fuel flowing through the fuel passages formed in the injectors 13a, 13b during circulation in the fuel injection system is adjusted by controlling the amount of fuel discharged by the low-pressure feed pump 16. Also, the fuel in the delivery pipes 14a, 14b is discharged from the relief valves 25a, 25b to the fuel discharge pipes 24a, 24b, respectively, and returned to the intake port of the low-pressure feed pump 16 through the fuel discharge pipe 24a.

The fuel injection system for an internal combustion engine thus configured according to the ninth embodiment of the invention is provided with the high-pressure fuel injection system and the low-pressure fuel injection system. The high-pressure fuel injection system includes the high-pressure pump 18, the high-pressure injectors 13a, and the delivery pipe 14a. The low-pressure fuel injection system includes the low-pressure feed pump 16, the low-pressure injectors 13b, and the delivery pipe 14b. When the high-pressure fuel injection system is stopped, the high-pressure pump 18 is stopped and the low-pressure feed pump 16 is driven. Thus, the low-pressure fuel is caused to flow close to the injection ports from the delivery pipes 14a, 14b through the fuel passages formed in the injectors 13a, 13b, respectively. As a result, the end portions of the injectors 13a, 13b are cooled. The rest of the fuel is returned to the intake port of the low-pressure feed pup 16 through the fuel discharge pipes 24a, 24b.

Because the fuel constantly flows close to all the injection ports through the fuel passages formed in the injectors 13a, 13b during circulation in the fuel injection system, the portions near the injection ports can be reliably cooled. It is, therefore, possible to provide more efficient cooling in the injectors 13a, 13b. The amount of fuel flowing through the fuel passages formed in the injectors 13a, 13b is easily adjusted by controlling the amount of fuel discharged by the low-pressure feed pump 16. Also, the rest of the fuel is returned to the intake port of the low-pressure feed pump 16, whereby the amount of fuel returned to the fuel tank 15 is reduced to reduce the amount of fuel volatilized in the fuel tank 15.

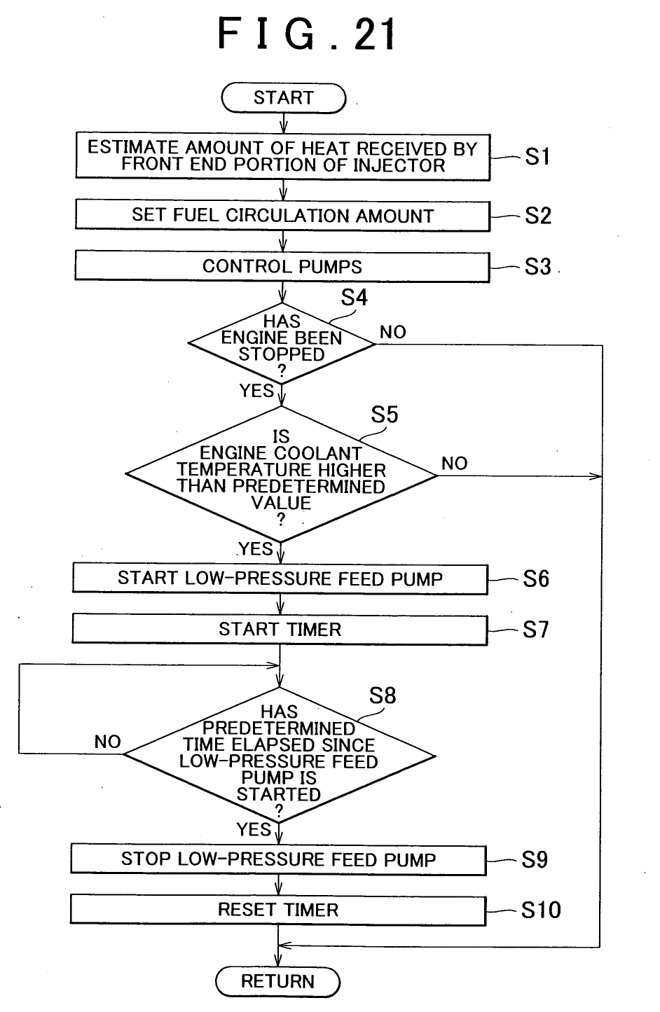

FIG. 21 is the flowchart of the fuel circulation control performed in the fuel injection system for an internal combustion engine according to a tenth embodiment of the invention. The general structure of the fuel injection system for an internal combustion engine according to the tenth embodiment is substantially the same as that according to the first embodiment of the invention. Therefore, the following description will be provided with reference to FIGS. 1 to 6. The components having the same functions as those in the first embodiment will be denoted by the same reference numerals, and will not be described below in detail.

The fuel circulation control is performed, in the following manner, in the fuel injection system for an internal combustion engine according to the tenth embodiment of the invention. As shown in FIG. 21, the amount of heat received by the front end portions of the injectors 13 is estimated in step S1. In step S2, the fuel circulation amount is set based on the estimated amount of heat received by the front end portions of the injectors 13. In the tenth embodiment of the invention, the amount of heat received by the front end portions of the injectors 13 is calculated in step S1 based on the difference between the amount of heat transferred from the engine and the amount of heat radiated due to the fuel injection. The amount of heat transferred from the engine is calculated based on the engine speed and the load. When the fuel injection system includes the high-pressure injection system and the low-pressure injection system as in the fifth embodiment described above, the amount of heat received by the end portions of the injectors 13 may be corrected based on the fuel injection ratio between the high-pressure fuel injection system and the low-pressure fuel injection system. In step S2, the fuel circulation amount is set based on the calculated amount of heat received by the front end portions of the injectors 13. In the tenth embodiment of the invention, the map indicating the fuel circulation amount with respect to the amount of heat received by the front end portions of the injectors 13 is stored in advance. Therefore, the fuel circulation amount may be set using this map.

In step S3, the low-pressure feed pump 16 and the high-pressure pump 18 are controlled based on the fuel circulation amount to adjust the amounts of fuel discharged from these pumps 16, 18. Thus, the amount of fuel corresponding to the operating state of the engine is supplied to the fuel passage to cool the end portion of the injector 13.

It is then determined in step S4 whether the engine has been stopped. If it is determined that the engine is still operating, the fuel circulation amount control is continuously performed. On the other hand, if it is determined that the engine has been stopped, step S5 is performed. In step S5, it is determined whether the temperature of the engine coolant is equal to or higher than a predetermined value. If it is determined that the temperature of the engine coolant is equal to or lower than the predetermined value, the engine is just stopped. On the other hand, if it is determined that the temperature of the engine coolant is higher than the predetermined value, steps S6, S7 are performed. In step S6, driving of the low-pressure feed pump 16 is started. Then, a timer is started in step S7. In step S8, it is determined whether a predetermined time has elapsed since driving of the low-pressure feed pump 16 is started. If it is determined in step S8 that the predetermined time has elapsed since driving of the low-pressure feed pump 16 is started, the low-pressure feed pump 16 is stopped in step S9, and the timer is reset to zero in step S10.

If the temperature of the engine coolant is higher than the predetermined value when the engine is stopped, it is determined that the temperature of the front end portion of each injector 13 is high and deposit is easily accumulated. Therefore, the fuel is caused to flow through the fuel passage formed in the injector 13 by driving the low-pressure feed pump 16 for the predetermined time. Thus, the end portion of the injector 13 is cooled.

In the tenth embodiment of the invention, the low-pressure feed pump 16 is stopped when the predetermined time has elapsed since driving of the low-pressure feed pump 16 is started. Alternatively, the low-pressure feed pump 16 may be stopped when the temperature of the engine coolant becomes equal to or lower than the predetermined value.

In the fuel injection system for an internal combustion engine according to the tenth embodiment of the invention, the amount of heat received by the front end portions of the injectors 13 is estimated, and the amount of fuel flowing through the fuel passage during circulation in the fuel injection system is set based on the estimated amount of heat received by the front end portions of the injectors 13. Accordingly, the portion near the injection port can be reliably cooled by causing the predetermined amount of fuel to flow close to the injection port through the fuel passage formed in each injector 13 during circulation in the fuel injection system. Thus, the temperature of the front end portion of each injector 13 is prevented from falling within a temperature range in which deposit is generated. Also, it is possible to suppress fluctuation in the fuel injection amount due to expansion and contraction of the needle valve 49 and the injection port 45.

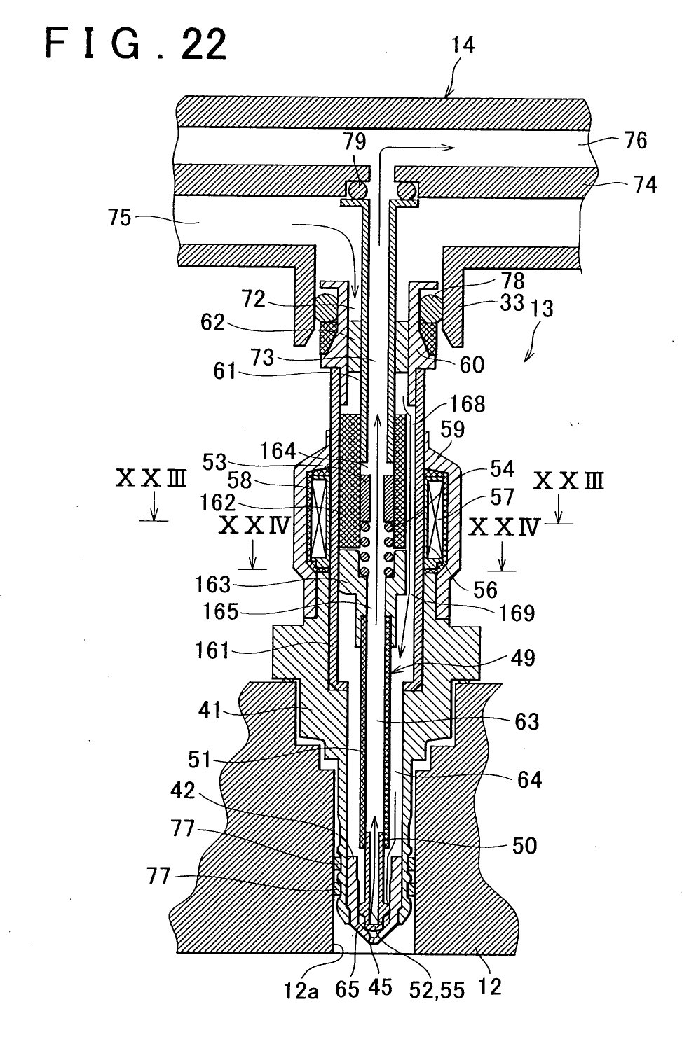

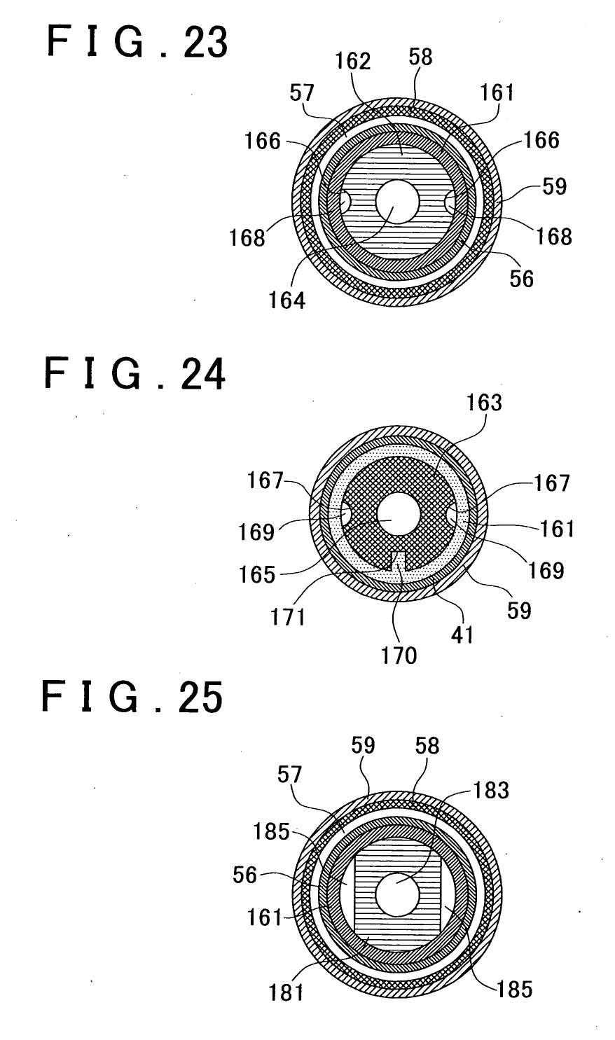

FIG. 22 is the cross sectional view of an injector in a fuel injection system for an internal combustion engine according to an eleventh embodiment of the invention. FIG. 23 is the cross sectional view taken along line XXIII-XXIII in FIG. 22. FIG. 24 is the cross sectional view taken along line XXIV-XXIV in FIG. 22. The components having the same functions as those in the embodiments described above will be denoted by the same reference numerals, and will not be described below in detail.

In the injector 13 in the fuel injection system for an internal combustion engine according to the eleventh embodiment of the invention, the valve body 42 is fixed to the front end portion of the holder 41, and the injection port 45 is formed in the front end portion of the valve body 42, as shown in FIGS. 22 to 24. A magnetic pipe 161 is fixed to the rear end portion of the holder 41. A cylindrical core 162 is fixed in the magnetic pipe 161. A cylindrical armature 163 is arranged on the front side of the core 162 with a predetermined distance kept therebetween such that the armature 163 is movable in the axial direction of the injector 13. The needle valve 49 is arranged in the holder 41 and the valve body 42 so as to be movable in the axial direction of the injector 13. The connection portion 51 is connected to the armature 163, and the valve element 50 is fitted in the valve body 42. The seal portion 52 is formed at the front end of the needle valve 49. A force of the compression coil spring 54 is applied to the needle valve 49 such that the seal portion 52 contacts the valve seat portion 55 of the valve body 42.

The coil 57 is wound around the magnetic pipe 161 via the bobbin 56. The connector 58 is formed around the coil 57. The yoke 59 is fixed around the connector 58. In the eleventh embodiment of the invention, the compression coil spring 54, the core 162, the armature 163, the bobbin 56, the coil 57, the connector 58, the yoke 59, etc. form the injection valve moving means. When electric power is supplied to the coil 57, an electromagnetic attraction force is generated in the core 162, and the armature 163 and the needle valve 49 are moved toward the rear of the injector 13 against the force of the compression coil spring 54, whereby the seal portion 52 moves away from the valve seat portion 55 of the valve body 42.

In the injector 13 according to the eleventh embodiment of the invention, the fuel passage, through which the fuel supplied from the outside of the injector 13 flows close to the injection port 45 and is then discharged to the outside of the injector 13, is formed. The needle valve 49 can block communication between the fuel passage and the injection port 45. Also, part of the fuel flowing through the fuel passage can be injected from the injection port 45 by permitting communication between the fuel passage and the injection port 45.

The space formed in the hollow needle valve 49 is used as the inner passage 63. Also, the outer passage 64 is formed around the needle valve 49. Two communication holes 65 that permit communication between the inner passage 63 and the outer passage 64 are formed in the needle valve 49. Also, the space formed in the cylindrical core 162 and the space formed in the cylindrical armature 163 are used as the center passages 164, 165, respectively. Notches 166, 167, which are formed in the outer faces of the core 162 and the armature 163 and which extend in the axial direction of the injector 13, are used as through-passages 168, 169, respectively. In addition, the fuel supply passage 72 is formed between the fuel introduction pipe 60 and the relief pipe 61, and the fuel discharge passage 73 is formed in the relief pipe 61.

Multiple (two, in the eleventh embodiment) through-passages 168 are formed in the core 162 at predetermined intervals in the circumferential direction, and multiple (two, in the eleventh embodiment) are formed in the armature 163 at predetermined intervals in the circumferential direction. A projection portion 170, which extends in the axial direction of the injector 13, is formed on the inner face of the magnetic pipe 161. A groove portion 171, which extends in the axial direction of the injector 13, is formed in the outer face of the armature 163. The projection portion 170 of the magnetic pipe 161 is fitted in the groove portion 171 of the armature 163. Accordingly, the armature 163 is movable with respect to the magnetic pipe 161 in the axial direction of the injector 13, but immovable in the circumferential direction of the injector 13. The through-passage 168 formed in the core 162 and the through-passage 169 formed in the armature 163 are located at the same position in the circumferential direction of the injector 13. In the eleventh embodiment of the invention, the projection portion 170 of the magnetic pipe 161 and the groove portion 171 of the armature 163 form rotation restricting means.

The fuel passage is thus formed. Through the fuel passage, the fuel is supplied from the first chamber 75 of the delivery pipe 14 to the fuel supply passage 72 formed in the injector 13, flows through the through-passages 168, 169 formed in the outer faces of the core 162 and the armature 163, the outer passage 64 formed around the needle valve 49, the communication holes 65, the inner passage 63, the center passages 164, 165 formed in the core 162 and the armature 163, and the fuel discharge passage 73, and is discharged to the second chamber 76 of the delivery pipe 14.

In the fuel injection system for an internal combustion engine thus configured according to the eleventh embodiment of the invention, when fuel injection is not performed, electric power is not supplied to the coil 57 of the injector 13. Accordingly, the seal portion 52 closely contacts the valve seat portion 55 due to a force of the compression coil spring 54, whereby the needle valve 49 blocks communication between the outer passage 64 and the injection port 45, which form part of the fuel passage. Therefore, the fuel in the delivery pipe 14 is supplied from the fuel supply passage 72 to the injector 13, flows through the through-passages 168, 169, the outer passage 64, the communication holes 65, the inner passage 63, the center passages 164, 165, and the fuel discharged passage 73, and is discharged to the delivery pipe 14. Namely, the fuel flows close to the injection port 45 of the injector 13 while circulating in the fuel injection system. As a result, the front end portion of the holder 41 and the valve body 42 can be cooled reliably.

On the other hand, when fuel injection is performed, electric power is supplied to the coil 57 of the injector 13. Accordingly, the needle valve 49 moves due to the electromagnetic attraction force, and the seal portion 52 moves away from the valve seat portion 55. Thus, communication between the outer passage 64 and the injection port 45, which form the fuel passage, is permitted. Accordingly, the fuel in the delivery pipe 14 is supplied from the fuel supply passage 72 to the injector 13, flows through the through-passages 168, 169, the outer passage 64, the communication holes 65, the inner passage 63, and the center passages 164, 165, and is discharged from the fuel discharge passage 73 to the delivery pipe 14. Also, part of the fuel flowing to the outer passage 64 is injected from the injection port 45 to the combustion chamber 11. Namely, the fuel flows close to the injection port 45 while circulating in the fuel injection system, and only a predetermined amount of fuel is injected from the injection port 45 to the combustion chamber 11. Also, the rest of the fuel is discharged to the delivery pipe 14. As a result, the end portion of the holder 41 and the valve body 42 are reliably cooled.

The through-passages 168, the through-passages 169, and the communication holes 65 are formed at predetermined intervals in the circumferential direction. Thus, unbalanced flow of the fuel flowing through the fuel passage is prevented. The projection portion 170 of the magnetic pipe 161 is fitted in the groove portion 171, whereby the armature 163 is immovable in the circumferential direction. In addition, the through-passage 168 formed in the outer face of the core 162 and the through-passage 169 formed in the outer face of the armature 168 are always at the same position in the circumferential direction. Accordingly, the fuel reliably flows through fuel passage while circulating in the fuel injection system.

In the fuel injection system for an internal combustion engine according to the eleventh embodiment of the invention, the base end portions of the injectors 13 are connected to the delivery pipe 14. The fuel passage, through which the fuel in the delivery pipe 14 flows close to the injection port formed at the front end portion of the valve body 42 and is then returned to the delivery pipe 14, is formed in the injector 13. Even if the needle valve 49 blocks communication between the fuel passage and the injection port 45, the fuel constantly flows close to the injection port 45 while circulating in the fuel injection system. Also, part of the fuel flowing through the fuel passage can be injected from the injection port 45 into the combustion chamber 11 by permitting communication between the fuel passage and the injection port 45.

Accordingly, the fuel in the delivery pipe 14 constantly flows close to the injection port 45 through the fuel passage and the returns to the delivery pipe 14 while circulating in the fuel injection system. Thus, the portion near the injection port 45 can be reliably cooled by the fuel flowing through the fuel passage during circulation in the fuel injection system. As a result, even if the fuel remains near the injection port 45, accumulation of deposit of the fuel is suppressed, and fluctuation in the fuel injection amount and deterioration of the combustion state can be suppressed.

In the fuel injection system for an internal combustion engine according to the eleventh embodiment of the invention, the space formed in the cylindrical core 162 and the space formed in the cylindrical armature 163 are used as the center passages 164, 165, respectively. Also, the notches 166, 167, which are formed in the outer faces of the core 162 and the armature 163 and which extend in the axial direction of the injector 13, are used as the through-passages 168, 169, respectively. The center passages 164, 165 and the through-passages 168, 169 are used as the fuel passage. Accordingly, the fuel passage can be formed without increasing the sizes of the core 162 and the armature 163. As a result, it is possible to provide a more compact fuel injection system. Also, the through-passages 168, 169 are formed at predetermined intervals in the circumferential direction. Thus, unbalanced flow of the fuel flowing through the fuel passage is prevented, which makes it possible to cool the portion near the injection port 45 uniformly in the circumferential direction using the fuel flowing through the fuel passage during circulation in the fuel injection system.

In addition, the projection portion 170 is formed on the inner face of the magnetic pipe 161, and the groove portion 171, in which the projection portion 170 is fitted, is formed in the outer face of the armature 163, whereby the armature 163 is immovable with respect to the magnetic pipe 161 in the circumferential direction. Accordingly, the through-passage 168 formed in the core 162 and the through-passage 169 formed in the armature 163 are always at the same position in the circumferential direction. Thus, the fuel can reliably flow through the fuel passage while circulating in the fuel injection system.

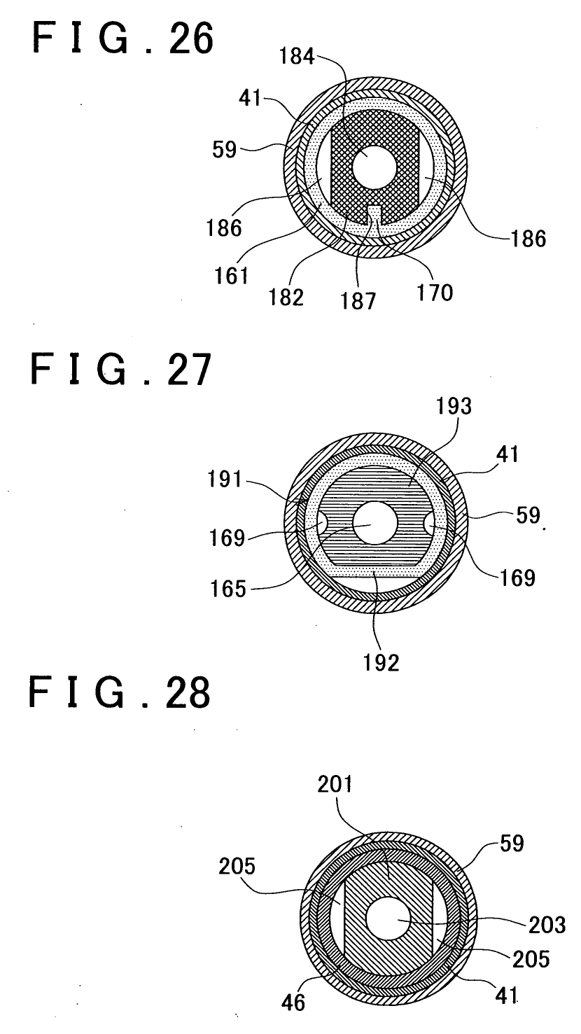

FIG. 25 is the cross sectional view showing a core of an injector in a fuel injection system for an internal combustion engine according to a twelfth embodiment of the invention. FIG. 26 is the cross sectional view showing an armature of the injector in the fuel injection system for an internal combustion engine according to the twelfth embodiment of the invention. FIG. 27 is the cross sectional view showing an armature of an injector in a fuel injection system for an internal combustion engine according to a modified example of the twelfth embodiment of the invention. The components having the same functions as those in the embodiments described above will be denoted by the same reference numerals, and will not be described below in detail.

In the injector in the fuel injection system for an internal combustion engine according to the twelfth embodiment of the invention, the space formed a cylindrical core 181 and the space formed in a cylindrical armature 182 are used as center passages 183, 184, respectively, as shown in FIGS. 25 and 26. Also, each of the core 181 and the armature 182 has a shape obtained by cutting both sides of the cylinder as shown in FIGS. 25 and 26, whereby through-passages 185, 186 are formed. In addition, the projection portion 170 is formed on the inner face of the magnetic pipe 161, and a groove portion 187, to which the projection portion 170 is fitted, is formed in the outer face of the armature 182. Accordingly, the armature 182 is movable with respect to the magnetic pipe 161 in the axial direction, but immovable with respect to the magnetic pipe 161 in the circumferential direction.

Accordingly, the center passages 183, 184 formed in the core 181 and the armature 182 and the through-passages 185, 186 of the core 181 and the armature 182 are used as the fuel passage.

In the fuel injection system for an internal combustion engine according to the twelfth embodiment of the invention, the space formed in the cylindrical core 181 and the space formed in the cylindrical armature 182 are used as the center passages 183, 184. Also, each of the core 181 and the armature 182 has the shape obtained by cutting the both side ends of the cylinder, whereby the through-passages 185, 186 are formed. The center passages 183, 184 and the through-passages 185, 186 are used as the fuel passage. Accordingly, the fuel passage can be formed without increasing the sizes of the core 181 and the armature 182. As a result, it is possible to provide a more compact fuel injection system.

The projection portion 170 is formed on the inner face of the magnetic pipe 161, and the groove portion 187, to which the projection portion 170 is fitted, is formed in the outer face of the armature 182. Thus, the armature 182 is immovable with respect to the magnetic pipe 161 in the circumferential direction. Accordingly, the through-passage 185 of the core 181 and the through-passage 182 of the armature 182 are always at the same position in the circumferential direction. Thus, the fuel reliably flows through the fuel passage while circulating in the fuel injection system.

The structure of the rotation restricting means for prohibiting rotation of the armature in the circumferential direction is not limited to the structure described above. For example, as shown in FIG. 27, a flat portion 912 is formed by flattening a part of the cylindrical magnetic pipe 191, and the armature 193 is formed in the shape substantially corresponding to the space formed in the magnetic pipe 191. Thus, the armature 193 is movable with respect to the magnetic pipe 191 in the axial direction, but immovable with respect to the magnetic pipe 191 in the circumferential direction.

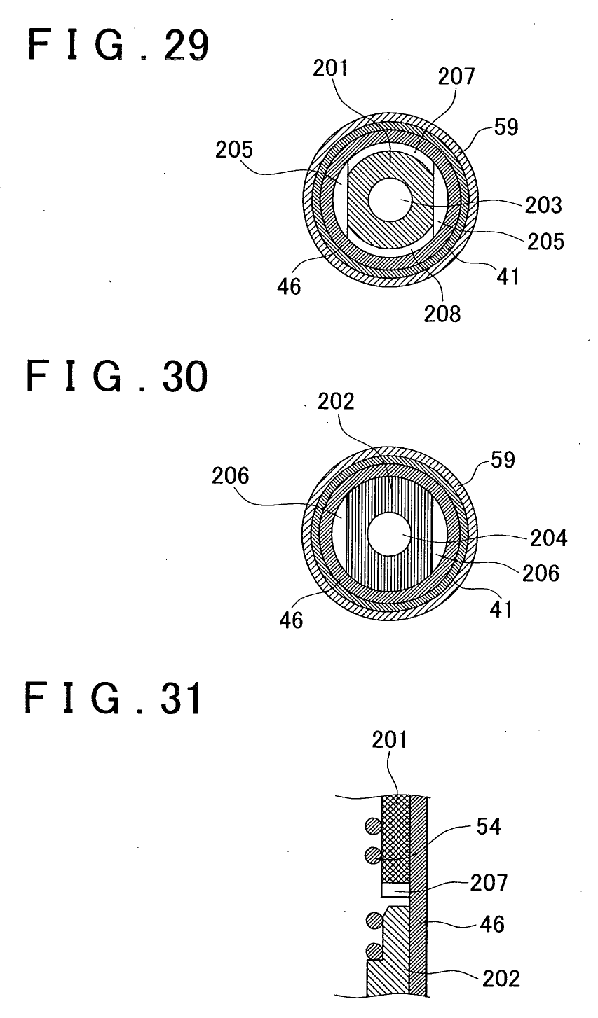

FIG. 28 is the cross sectional view showing the upper face of a core of an injector in a fuel injection system for an internal combustion engine according to a thirteenth embodiment of the invention. FIG. 29 is the cross sectional view showing the lower face of the core of the injector in the fuel injection system for an internal combustion engine according to the thirteenth embodiment of the invention. FIG. 30 is the cross sectional view showing an armature of the injector in the fuel injection system for an internal combustion engine according to the thirteenth embodiment of the invention. FIG. 31 is the vertical cross sectional view showing the core and the armature of the injector according to the thirteenth embodiment of the invention. The components having the same functions as those in the embodiments described above will be denoted by the same reference numerals, and will not be described below in detail.

In the injector in the fuel injection system for an internal combustion engine according to the thirteenth embodiment of the invention, the space formed a core 201 and the space formed an armature 202 are used as center passages 203, 204, respectively. In addition, each of the core 201 and the armature 232 has a shape obtained by cutting the both end portions of the cylinder, whereby through-passages 205, 206 are formed, respectively, as shown in FIGS. 28 to 31. In addition, communication grooves 207, 208 that communicate with both of the through-passages 205, 206 are formed in the lower face of the core 201, which faces the upper face of the armature 202. The communication grooves 207, 208 are formed along the periphery of the lower face of the core 201.

Accordingly, the armature 202 is movable with respect to the core 201 in the circumferential direction. However, communication between the through-passage 205 of the core 201 and the through-passage 206 of the armature 202 is constantly permitted by the communication grooves 207, 208. Accordingly, the center passages 203, 204 and the through-passages 205, 206 of the core 201 and the armature 202, and the communication grooves 207, 208 form the fuel passage.

In the fuel injection system for an internal combustion engine according to the thirteenth embodiment of the invention, the space formed in the cylindrical core 201 and the space formed in the cylindrical armature 202 are used as the center passages 203, 204, respectively. In addition, the through-passages 205, 206 are formed by forming the each of the core 201 and the armature 202 by cutting the both side portions of the cylinder. Also, the communication grooves 207, 208, which are communicated with the through-passages 205, 206, are formed in the lower face of the core 201. The center passages 203, 204, the through-passages 205, 206 and the communication grooves 207, 208 are used as the fuel passage. Accordingly, the fuel passage can be formed without increasing the sizes of the core 201 and the armature 202. As a result, it is possible to provide a more compact fuel injection system.

The armature 202 is movable in the circumferential direction. However, communication between the through-passages 205 of the core 201 and the through-passages 206 of the armature 202 is constantly permitted by the communication grooves 207, 208. Accordingly, the through-passages 205, 206 serving as the fuel passage are not blocked. As a result, the fuel reliably flows through the flow passage while circulating in the fuel injection system.

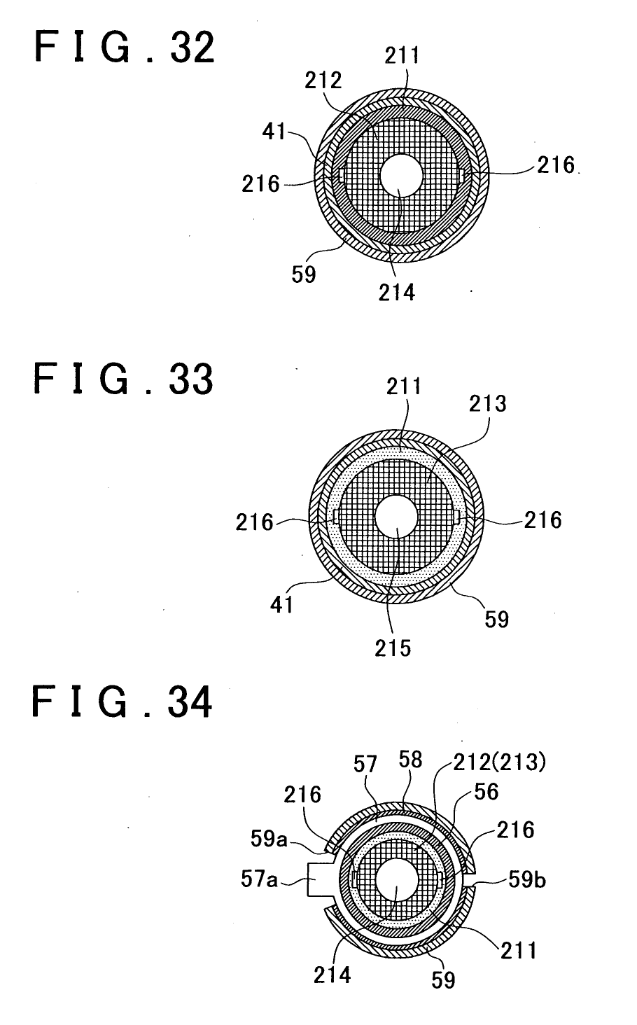

FIG. 32 is the cross sectional view showing a core of an injector in a fuel injection system for an internal combustion engine according to a fourteenth embodiment of the invention. FIG. 33 is the cross sectional view of an armature of the injector in the fuel injection system for an internal combustion engine according to the fourteenth embodiment of the invention. The components having the same functions as those in the embodiments described above will be denoted by the same reference numerals, and will not be described below in detail.

In the injector in the fuel injection system for an internal combustion engine according to the fourteenth embodiment of the invention, a cylindrical core 212 is fixed in a magnetic pipe 211 forming the injection valve moving means, and a cylindrical armature 213 is arranged on the front side of the core 212 with a predetermined distance kept therebetween so as to be movable in the axial direction of the injector. The space formed in the cylindrical core 212 and the space formed in the cylindrical armature 213 are used as center passages 214, 215. Two through-grooves 216 are formed in the inner face of the magnetic pipe 211 at predetermined intervals in the circumferential direction. The through-grooves 216 extend in the axial direction of the injector.

The center passages 214, 215 formed in the core 212 and the armature 213 and the through-grooves 216 formed in the inner face of the magnetic pipe 211 form the fuel passage.

In the fuel injection system for an internal combustion engine according to the fourteenth embodiment of the invention, the space formed the cylindrical core 212 and the space formed in the cylindrical armature 213 are used as the center passage 214, 215, respectively. In addition, the through-grooves 216, which extend in the axial direction of the injector, are formed in the inner face of the magnetic pipe 211. The center passages 214, 215 and the through-grooves 216 are used as the fuel passage. Accordingly, it is no longer necessary to form each of the core 212 and the armature 213 into a shape obtained by cutting both side portions of the cylinder to form the fuel passage. As a result, it is possible to provide a more compact fuel injection system.

FIG. 34 is the cross sectional view showing a core of an injector in a fuel injection system for an internal combustion engine according to a fifteenth embodiment of the invention. The components having the same functions as those in the embodiments described above will be denoted by the same reference numerals, and will not be described below in detail.

In the injector in the fuel injection system for an internal combustion engine according to the fifteenth embodiment of the invention, the core 212 is fixed in the magnetic pipe 211, and the armature 213 is arranged adjacent to the core 212 so as to be movable in the axial direction of the injector. Also, the coil 57 is wound around the magnetic pipe 211 via the bobbin 56. The connector 58 is formed around the coil 57. The yoke 59 is fixed around the connector 58. When electric power is supplied to the coil 57, an electromagnetic attraction force is generated in the core 212, whereby the needle valve is moved via the armature 213. The coil 57 is provided with a terminal portion 57a. The yoke 59 has notches 59a, 59b. The notch 59a is formed at the position corresponding to the terminal portion 57a. The notch 59b is formed at the position opposite to the notch 59a. Magnetic paths are not formed at the notches 59a, 59b.

The space formed in the cylindrical core 212 and the space formed in the cylindrical armature 213 are used as the center passages 214, 215. In addition, the two through-grooves 216, which extend in the axial direction of the injector, are formed in the inner face of the magnetic pipe 211. The through-passages 216 are formed at the positions corresponding to the terminal portion 57a, namely, the positions corresponding to the notches 59a, 59b formed in the yoke 59.

The center passages 214, 215 formed in the core 212 and the armature 213, and the through-passages 216 formed in the inner face of the magnetic pipe 211 are used as the fuel passage.

In the fuel injection system for an internal combustion engine according to the fifteenth embodiment of the invention, the space formed in the cylindrical core 212 and the space formed in the cylindrical armature 213 are used as the center passages 214, 215. In addition, the through-grooves 216, which extend in the axial direction of the injector, are formed in the inner face of the magnetic pipe 211. The through-grooves 216 are formed at the positions corresponding to the terminal portion 57a of the coil 57, namely, the positions corresponding to the notches 59a, 59b formed in the yoke 59. The center passages 214, 215 and the through-grooves 216 are used as the fuel passage. Accordingly, it is not longer necessary to form each of the core 212 and the armature 213 into a shape obtained by cutting the both side portions of the cylinder to form the fuel passage. It is, therefore, possible to provide a more compact fuel injection system. Also, because the through-grooves 216 used as the fuel passage are formed at the positions where magnetic paths are not formed, reduction in the attraction force can be prevented.

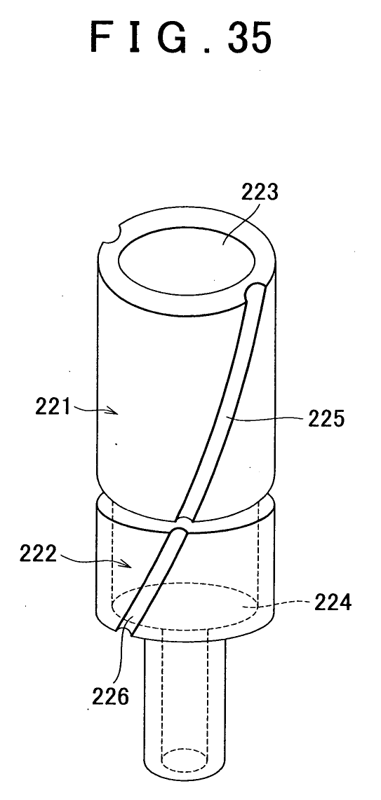

FIG. 35 is the view schematically showing a core and an armature of an injector in a fuel injection system for an internal combustion engine according to a sixteenth embodiment of the invention. The components having the same functions as those in the embodiments described above will be denoted by the same reference numerals, and will not be described below in detail.

In the injector in the fuel injection system for an internal combustion engine according to the sixteenth embodiment of the invention, the space formed a cylindrical core 221 and the space formed in a cylindrical armature 222 are used as center passages 223, 224, respectively, as shown in FIG. 35. Also, through-passages 225, 226 are formed in the outer faces of the core 221 and the armature 222, respectively. The through-passages 225, 226 are formed so as to be inclined with respect to the axis of the core 221 and the armature 222. Alternatively, the through-passages 225, 226 are formed in a spiral fashion with respect to the axis of the core 221 and the armature 222.

The center passages 223, 224 and the inclined through-passages 225, 226, which are formed in the core 221 and the armature 222, respectively, are used as the fuel passage, and the fuel flows through the through-passages 225, 226 while swirling.

In the fuel injection system for an internal combustion engine according to the sixteenth embodiment of the invention, the center passages 223, 224 and the through-passages 225, 226, which are inclined with respect to the axis of the core 221 and the armature 222, are formed in the core 221 and the armature 222, which form the injection valve moving means. The center passages 223, 224 and the through-passages 225, 226 are used as the fuel passage. Accordingly, the fuel passage can be easily formed without increasing the sizes of the core 221 and the armature 222. In addition, the temperature of the fuel is uniform in the injector, because the fuel flows through the through-passages 225, 226 while swirling. As a result, the fuel appropriately flows through the fuel passage while circulating in the fuel injection system, and the end portion of the injector can be reliably cooled.

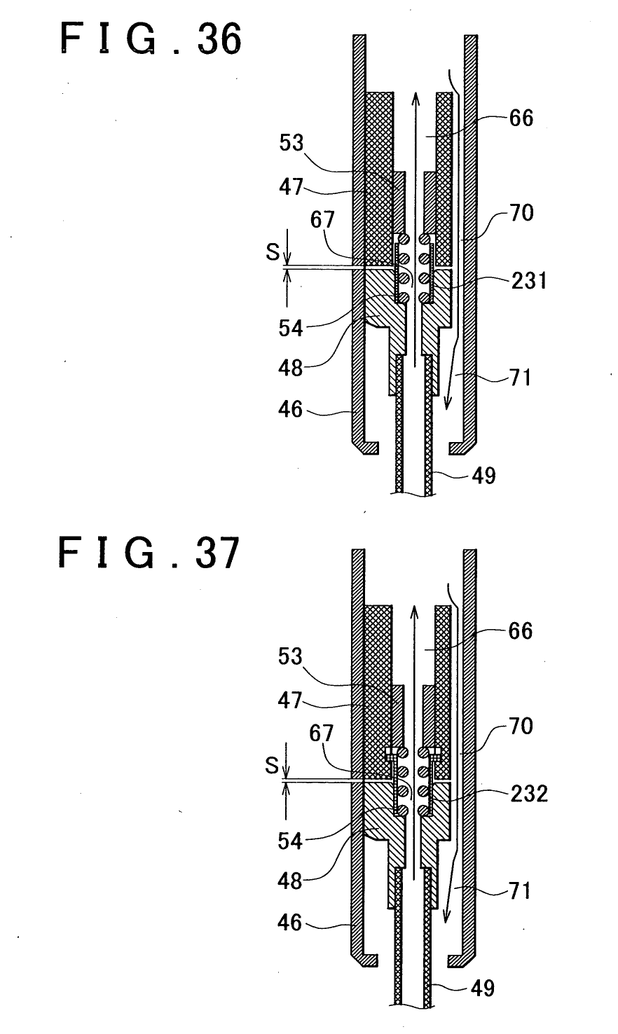

FIG. 36 is the vertical cross sectional view showing a core and an armature of an injector in a fuel injection system for an internal combustion engine according to a seventeenth embodiment of the invention. The components having the same functions as those in the embodiments described above will be denoted by the same reference numerals, and will not be described below in detail.

In the injector of the fuel injection system for an internal combustion engine according to the seventeenth embodiment of the invention, as shown in FIG. 36, the core 47 is fixed in the magnetic pipe 46, the armature 48 is arranged in series with the core 47 with the predetermined distance S kept therebetween. The armature 48 is movable in the axial direction of the injector. The rear end portion of the needle valve 49 is connected to the armature 48. The compression spring 54 is arranged between the adjust pipe 53 and the armature 48. The center passages 66, 67 are formed inside the core 47 and the armature 48, respectively. In addition, the through-passages 70, 71 are formed around the core 47 and the armature 48, respectively.

A seal pipe (fuel seal) 231, made of non-magnetic material, is arranged inside the core 47 and the armature 48. The seal pipe 231 is fixed to the armature 48 at one end. The seal pipe 231 is movable with respect to the core 47 at the other end. The seal pipe 231 prevents the fuel from leaking between the center passages 66, 67 and the through-passages 70, 71 through the clearance corresponding to the predetermined distance S.

In the fuel injection system for an internal combustion engine according to the seventeenth embodiment of the invention, the core 47 and the armature 48 are arranged in the magnetic pipe 47, whereby the center passages 66, 67 and the through-passages 70, 71, which form the fuel passages, are formed. In addition, the seal pipe 231 is arranged inside the core 47 and the armature 48 so as to closely contact the inner faces of the core 47 and the armature 48, whereby the fuel is prevented from leaking between the center passages 66, 67 and the through-passages 70, 71.

Accordingly, the fuel passage can be easily formed without increasing the sizes of the core 47 and the armature 48. It is, therefore, possible to provide a more compact fuel injection system. Also, the seal pipe 231 prevents the fuel from leaking between the center passages 66, 67 and the through-passages 70, 71 through the clearance corresponding to the distance S, which suppress fluctuation in the temperature of the fuel flowing through the fuel passage. As a result, the end portion of the injector is reliably cooled.

In the seventeenth embodiment of the invention, the seal pipe 231 is fixed to the armature 48 at one end, and the seal pipe 231 is movable with respect to the core 47 at the other end. However, the seal pipe 231 may be fixed to the core 47 at one end, and the seal portion 231 may be movable with respect to the armature 48 at the other end. Alternatively, the seal pipe may be formed integrally with one of the core 47 and the armature 48, and movable with respect to the other of the core 47 and the armature 48 via a non-magnetic body.

FIG. 37 is the vertical cross sectional view showing a core and an armature of an injector in a fuel injection system for an internal combustion engine according to an eighteenth embodiment of the invention. The components having the same functions as those in the embodiments described above will be denoted by the same reference numerals, and will not be described below in detail.

In the injector in the fuel injection system for an internal combustion engine according to the eighteenth embodiment of the invention, as shown in FIG. 37, a cylindrical fuel seal 232, made of elastic material, is arranged inside the core 47 and the armature 48 so as to closely contact the inner faces of the core 47 and the armature 48. The fuel seal 232 is fixed to the armature 48 at one end. The fuel seal 232 can contact the adjust pipe 53, integrally formed with the core 47, at the other end. The fuel seal 232 prevents the fuel from leaking between the center passages 66, 67 and the through-passages 70, 71 through the clearance corresponding to the predetermined distance S. In addition, the fuel seal 232 can reduce a bounce of the needle valve 49.

In the fuel injection system for an internal combustion engine according to the eighteenth embodiment of the invention, the core 47 and the armature 48 are arranged in the magnetic pipe 47, whereby the center passages 66, 67 and the through-passages 70, 71, which form the fuel passage, are formed. Also, the fuel seal 232 is arranged inside the core 47 and the armature 48 so as to closely contact the inner faces of the core 47 and the armature 48, whereby the fuel is prevented from leaking between the center passages 66, 67 and the through-passages 70, 71.

Accordingly, the fuel passage can be easily formed without increasing the sizes of the core 47 and the armature 48. It is, thus, possible to provide a more compact fuel injection system. Also, the fuel seal 232 prevents the fuel from leaking between the center passages 66, 67 and the through-passages 70, 71 through the clearance corresponding to the distance S, which suppress fluctuation in the temperature of the fuel flowing through the fuel passage. As a result, the end portion of the injector is reliably cooled. When the needle valve 49 moves, the end portion of the fuel seal 232 contacts the core 47 or the adjust pipe 53, whereby a bounce of the needle valve 49 is reduced. As a result, an appropriate amount of fuel is injected.

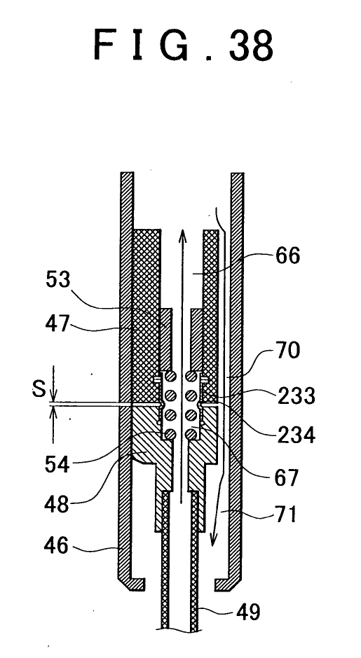

FIG. 38 is the vertical cross sectional view showing a core and an armature of an injector in a fuel injection system for an internal combustion engine according to a nineteenth embodiment of the invention. The components having the same functions as those in the embodiments described above will be denoted by the same reference numerals, and will not be described below in detail.

In the injector of the fuel injection system for an internal combustion engine according to the nineteenth embodiment of the invention, as shown in FIG. 38, a cylindrical fuel seal 233, made of elastic material, is arranged inside the core 47 and the armature 48 so as to closely contact the inner faces of the core 47 and the armature 48. The fuel seal 233 is connected to the armature 48 at one end. The fuel seal 233 is connected to the core 47 at the other end. A sag portion 234 is formed in the middle portion of the fuel seal 233. The fuel seal 233 prevents the fuel from leaking between the center passages 66, 67 and the through-passages 70, 71 through the clearance corresponding to the predetermined distance S. Also, the fuel seal 233 reduces a bounce of the needle valve 49.

In the fuel injection system for an internal combustion engine according to the nineteenth embodiment of the invention, the core 47 and the armature 48 are arranged in the magnetic pipe 46, whereby the center passages 66, 67 and the through-passages 70, 71, which form the fuel passage, are formed. Also, the fuel seal 233 is arranged inside the core 47 and the armature 48 so as to closely contact the inner faces of the core 47 and the armature 48, whereby the fuel is prevented from leaking between the center passages 66, 67 and the through-passages 70, 71.

Accordingly, the fuel passage can be easily formed without increasing the sizes of the core 47 and the armature 48. It is, thus, possible to provide a more compact fuel injection system. Also, the fuel seal 233 prevents the fuel from leaking between the center passages 66, 67 and the through-passages 70, 71 through the clearance corresponding to the distance S, which suppress fluctuation in the temperature of the fuel flowing through the fuel passage. As a result, the end portion of the injector is reliably cooled. When the needle valve 49 moves, the fuel seal 233 sags, whereby a bounce of the needle valve 49 is reduced. As a result, an appropriate amount of fuel can be injected.

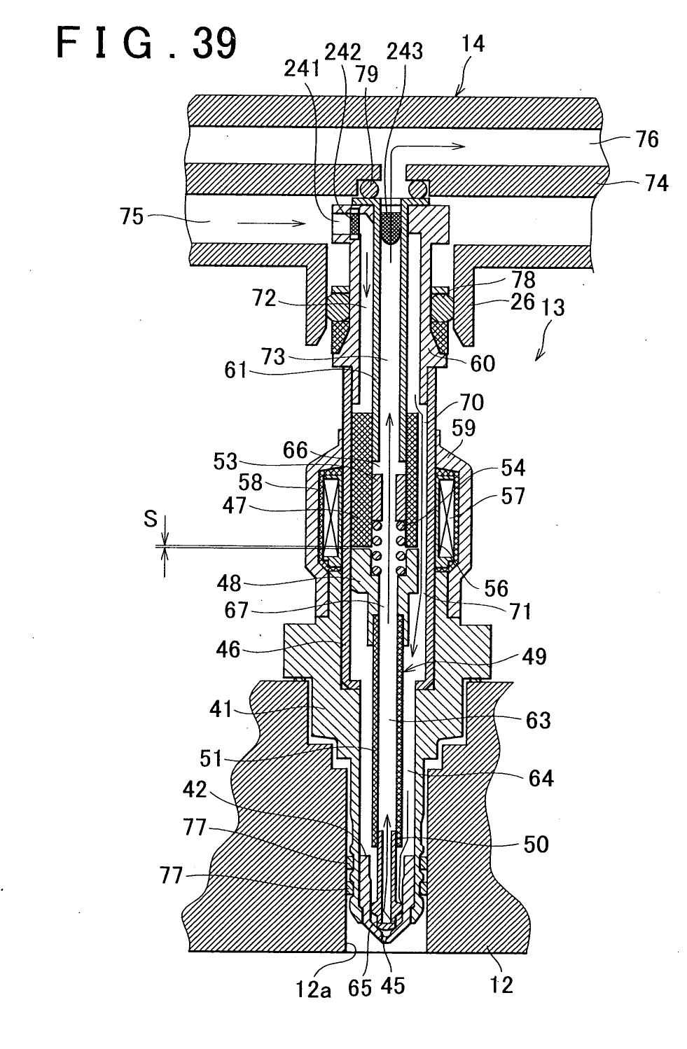

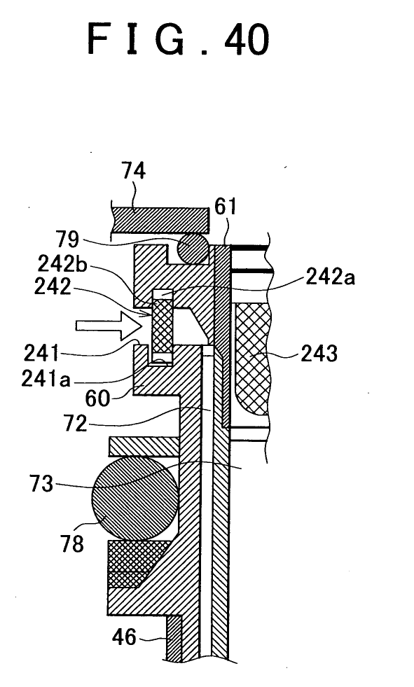

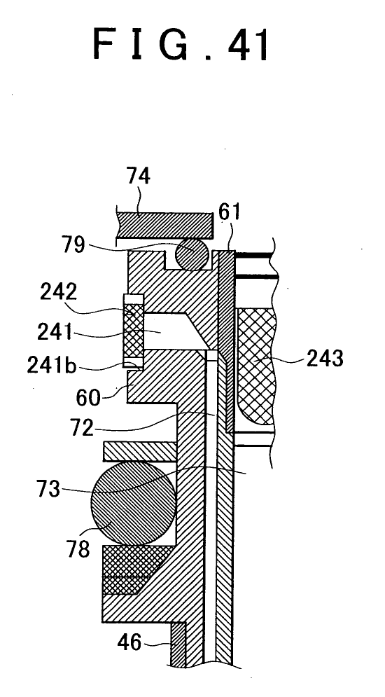

FIG. 39 is the cross sectional view of an injector in a fuel injection system for an internal combustion engine according to a twentieth embodiment of the invention. FIG. 40 is the cross sectional view showing a fuel supply portion of the injector in the fuel injection system for an internal combustion engine according to the twentieth embodiment of the invention. Each of FIGS. 41 to 44 is the cross sectional view of a modified example of the fuel supply portion of the injector in the fuel injection system for an internal combustion engine according to the twentieth embodiment of the invention. The components having the same functions as those in the embodiments described above will be denoted by the same reference numerals, and will not be described below in detail.

In the fuel injection system for an internal combustion engine according to the twentieth embodiment of the invention, as shown in FIGS. 39 and 40, the fuel introduction pipe 60 is connected to the rear end portion of the magnetic pipe 46 of the injector 13, and the relief pipe 61 is connected to the rear end portion of the core 47, whereby the fuel supply passage 72 is formed between the fuel introduction pipe 60 and the relief pipe 61, and the fuel discharge passage 73 is formed inside the relief pipe 61. The fuel supply pipe 72 has a fuel introduction port 241 that opens into the first chamber 75 of the delivery pipe 14. The fuel introduction port 241 opens into the first chamber 75 so as to face the upstream side of the first chamber 75. A first fuel filter 242 is arranged in the fuel introduction port 241. The fuel discharge passage 73 extends in the axial direction, and is communicated with the second chamber 76 of the delivery pipe 14. A second fuel filter 243 is arranged at the position where communication is provided between the fuel discharge passage 73 and the second chamber 76.

In the injector 13 according to the twentieth embodiment of the invention, the side-feed configuration is employed on the fuel supply side, and the top-feed configuration is employed on the fuel discharge side. The fuel passage is formed in the injector 13. Through the injector 13, the fuel is supplied from the first chamber 75 of the delivery pipe 14 to the fuel supply passage 72 formed in the injector 13, flows through the through-passages 70, 71 formed in the outer faces of the core 47 and the armature 48, the outer passage 64 formed around the needle valve 49, the communication holes 65, the inner passage 63, the center passages 66, 67 formed inside the core 47 and the armature 48, and the fuel discharge passage 73, and is then discharged to the second chamber 76 of the delivery pipe 14. The fuel filters 242, 243 are arranged in the fuel supply passage 72 and the fuel discharge passage 73, respectively. In this case, the first fuel filter 242 arranged on the fuel supply side (side feed) is formed by fitting a mesh filter body 242b inside a ring-shaped fitting ring 242a. The first fuel filter 242 is fixed in a fitting portion 241a of the fuel introduction port 241.

In the fuel injection system for an internal combustion engine according to the twentieth embodiment of the invention, the side-feed configuration is employed on the fuel supply side of the injector 13, and the top-feed configuration is employed on the fuel discharge side of the injector 13. The fuel filters 242, 243 are arranged in the fuel supply passage 72 and the fuel discharge passage 73, respectively. Arranging the fuel filters 242, 243 on the fuel supply side and fuel discharge side of the injector 13, respectively, makes it possible to supply and discharge sufficient amounts of fuel, and to reliably prevent foreign matter from entering the injector 13. Also, using the different fuel filters 242, 243 on the fuel supply side and the fuel discharge side, respectively, makes it possible to simplify the structure of each of the fuel filters 242, 243, and to reduce the cost.

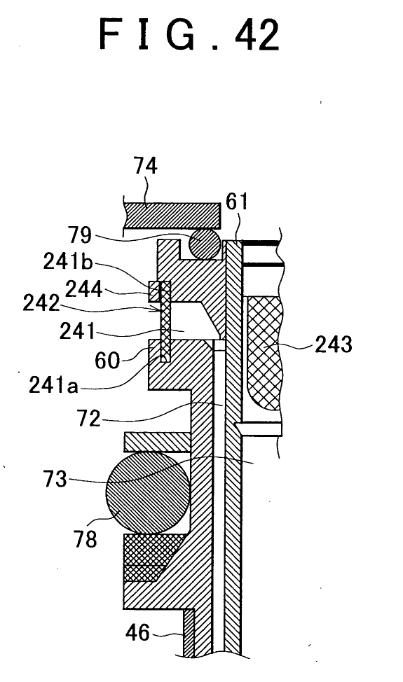

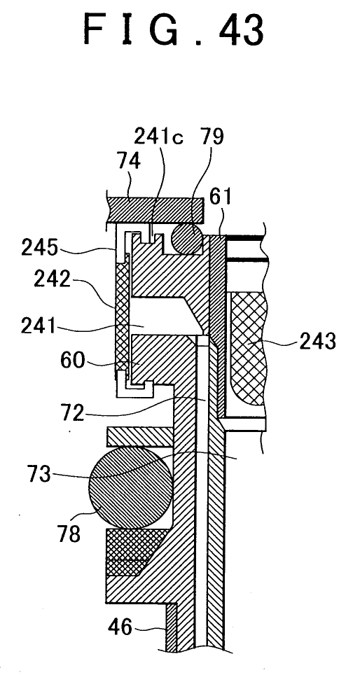

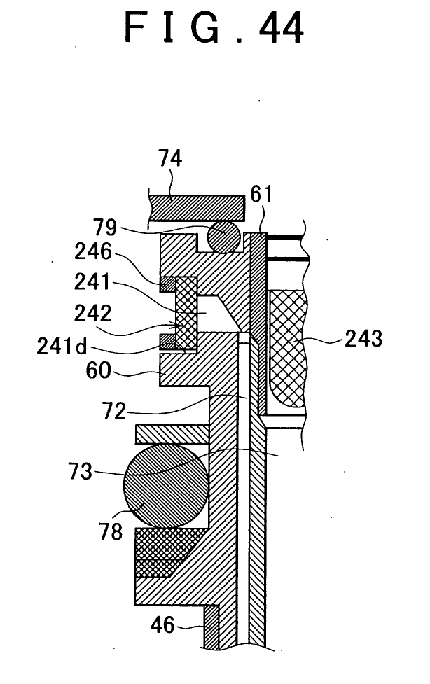

In the twentieth embodiment of the invention, the first fuel filter 242 is fitted in the fuel introduction port 241 of the fuel supply passage 72. However, the structure used to fit the first fuel filter 242 is not limited to the structure in the twentieth embodiment. For example, as shown in FIG. 41, an engagement portion 241b may be formed in end portion of the fuel introduction port 241, and the first fuel filter 242 may be fixed to the engagement portion 241b. Alternatively, as shown in FIG. 42, the first fuel filter 242 may be fixed to the fitting portion 241a and the engagement portion 241b by an engagement member 244. Alternatively, as shown in FIG. 43, an engagement portion 241c may be formed on the outer side of the fuel introduction port 241, and the first fuel filter 242 may be fixed to the engagement portion 241c by a hook 245 attached to the first fuel filter 242. Alternatively, as shown in FIG. 44, a concave portion 241d may be formed in the fuel introduction port 241, and the first fuel filter 242 may be fixed in the concave portion 241d by an engagement member 246.

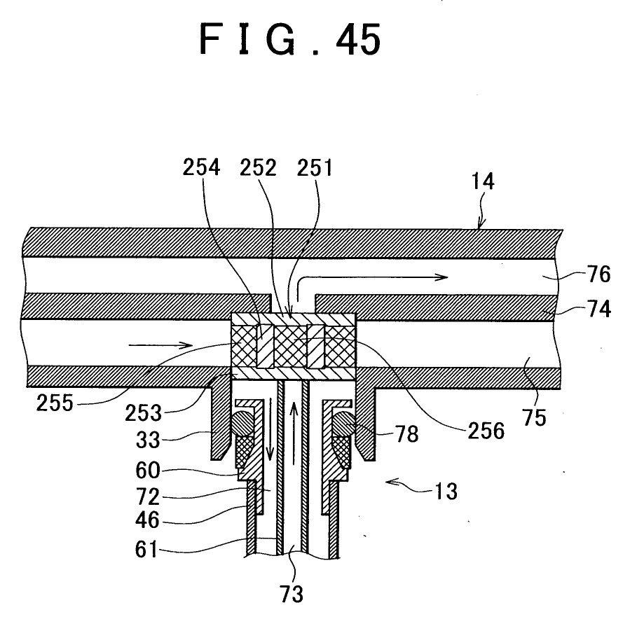

FIG. 45 is the cross sectional view showing a connection portion at which the injector is connected to the delivery pipe in a fuel injection system for an internal combustion according to a twenty-first embodiment of the invention. The components having the same functions as those in the embodiments described above will be denoted by the same reference numerals, and will not be described below in detail.

In the fuel injection system for an internal combustion engine according to the twenty-first embodiment of the invention, as shown in FIG. 45, the fuel introduction pipe 60 is connected to the rear end portion of the magnetic pipe 46 of the injector 13, and the relief pipe 61 is connected to the rear end portion of the core 47, whereby the fuel supply passage 72 is formed between the fuel introduction pipe 60 and the relief pipe 61, and the fuel discharge passage 73 is formed inside the relief pipe 61. Then, the rear end portion of the injector 13 is connected to the delivery pipe 14, and a fuel filter 251 is fitted to the connection portion, whereby the fuel filter 251 is arranged between the first chamber 75 and the fuel supply passage 72, and between the second chamber 76 and the fuel discharge passage 73.

In the fuel filter 251, a support pipe 254 is arranged between ring-shaped upper and lower support rings 252, 253, the support pipe 254 and the support rings 252, 253 are connected by a connection member (not shown), and filter bodies 255, 256 are arranged between the upper and lower support rings 252, 253. The filter body 255 is arranged outside the support pipe 254, and the filter body 256 is arranged inside the support pipe 254. Then, the fuel filter 251 is fixed to the partition wall 74 and the flange portion 33 of the delivery pipe 14, whereby the filter body 255 is arranged between the first chamber 75 and the fuel supply passage 72, and the filter body 256 is arranged between the second chamber 76 and the fuel discharge passage 73.

In the injector 13 according to the twenty-first embodiment of the invention, the fuel passage is formed. Through the fuel passage, the fuel is supplied from the first chamber 75 of the delivery pipe 14 to the fuel supply passage 72 formed in the injector 13 through the filter body 255 of the fuel filter 251, flows close to the injection port (not shown), flows through the fuel discharge passage 73 and the filter body 256 of the fuel filter 251, and is discharged to the second chamber 76 of the delivery pipe 14.

In the fuel injection system for an internal combustion engine according to the twenty-first embodiment of the invention, the fuel filter 251 is fitted to the connection portion at which the rear end portion of the injector 13 and the delivery pipe 14 are connected to each other. The filter body 255 is arranged between the first chamber 75 and the fuel supply passage 72, and the filter body 256 is arranged between the second chamber 76 and the fuel discharge passage 73. Accordingly, one fuel filter 251 having two filter bodies 255, 256 is arranged such that the filter body 255 is arranged on the fuel supply side and the filter body 256 is arranged on the fuel discharge side. Thus, the assembly is performed more easily, while sufficient amounts of fuel are supplied and discharged. In addition, foreign matter is reliably prevented from entering the injector 13.

In the embodiments described above, the fuel injection system for an internal combustion engine according to the invention is applied to various internal combustion engines. However, the fuel injection system according to the invention may be applied to any one of direct-injection internal combustion engines where fuel is directly injected in combustion chambers or port-injection internal combustion engines where fuel is injected to the intake ports. Also, the fuel injection system according to the invention may be applied to internal combustion engines having both injectors that directly inject fuel into combustion chambers and injectors that inject fuel to intake ports. In any of these cases, the same effects as those obtained in the embodiments described above can be obtained.

As described so far, in the fuel injection system for an internal combustion engine according to the invention, the fuel constantly flows close to the fuel injection port while circulating in the fuel injection system, and part of the fuel flowing through the fuel passage can be injected from the injection port. The fuel injection system according to the invention may be applied to any types of internal combustion engines.

What is claimed is:

1. A fuel injection system for an internal combustion engine, comprising:
a fuel injection device;
a fuel injection port formed in a front end portion of the fuel injection device;
a fuel passage through which fuel supplied from an outside of the fuel injection device flows close to the fuel injection port and is then discharged to the outside of the fuel injection device; and
a fuel injection valve that permits communication between the fuel passage and the fuel injection port to inject part of the fuel flowing through the fuel passage.

2. The fuel injection system for an internal combustion engine, according to claim 1, wherein
an outer face of the front end portion of the fuel injection device is fixed to a body of an internal combustion engine via a fitting seal, and
the fuel passage extends, beyond the fitting seal, to a position close to a front end of the fuel injection device.

3. The fuel injection system for an internal combustion engine, according to claim 1, wherein
the fuel passage includes:
an inner passage that is formed inside the fuel injection valve by forming the injection valve in a hollow shape;
an outer passage that is formed around the fuel injection valve; and
a communication hole that is formed in a front end portion of the fuel injection valve, and that permits communication between the inner passage and the outer passage.

4. The fuel injection system for an internal combustion engine according to claim 3, wherein
a plurality of the communication holes are formed at regular intervals in a circumferential direction.

5. The fuel injection system for an internal combustion engine according to claim 3, wherein
a plurality of the outer passages are formed at regular intervals in a circumferential direction.

6. The fuel injection system for an internal combustion engine according to claim 3, wherein
the outer passage is inclined with respect to an axis of the fuel injection device.

7. The fuel injection system for an internal combustion engine according to claim 1, wherein
the fuel passage includes:
an outer passage formed around the fuel injection valve;
a discharge passage through which the fuel is discharged from the fuel injection device; and
a passage that is formed in the front end portion of the fuel injection device, and that permits communication between the outer passage and the discharge passage.

8. The fuel injection system for an internal combustion engine according to claim 1, further comprising:
a fuel injection valve moving device that is used to move the fuel injection valve; wherein
a force is applied from a force application member to the fuel injection valve such that communication between the fuel passage and the fuel injection port is blocked,
the communication between the fuel passage and the fuel injection port is permitted by moving the fuel injection valve using fuel injection valve moving device, and
the fuel passage is formed so as to pass through the fuel injection valve moving device.

9. The fuel injection system for an internal combustion engine according to claim 8, wherein
the fuel injection valve moving device includes:
a magnetic pipe;
a core that is fixed to an inner face of the magnetic pipe;
an armature that is arranged in series with the core, that is connected to a base end portion of the fuel injection valve, and that is supported by the inner face of the magnetic pipe so as to be movable in an axial direction of the fuel injection device; and
a coil which is arranged around the magnetic pipe, and to which electric power is supplied.

10. The fuel injection system for an internal combustion engine according to claim 9, wherein
the fuel passage is formed inside the core and the armature so as to pass through the core and the armature, and formed along outer faces of the core and the armature.

11. The fuel injection system for an internal combustion engine according to claim 10, wherein
the fuel passage is formed by forming notches, which extend in the axial direction of the fuel injection device, in the outer faces of the core and the armature.

12. The fuel injection system for an internal combustion engine according to claim 11, wherein
a communication groove, which permits communication between the notch formed in the outer face of the core and the notch formed in the outer face of the armature, is formed in the core or the armature.

13. The fuel injection system for an internal combustion engine according to claim 10, further comprising:
a rotation restricting device that restricts rotation of the armature.

14. The fuel injection system for an internal combustion engine according to claim 9, wherein
the fuel passage is formed inside the core and the armature so as to pass through the core and the armature, and formed along the inner face of the magnetic pipe.

15. The fuel injection system for an internal combustion engine according to claim 9, wherein
the fuel passage is formed at a position corresponding to a terminal portion of the coil.

16. The fuel injection system for an internal combustion engine according to claim 9, wherein
a fuel seal, which prevents a fuel leak, is arranged between the core and the armature.

17. The fuel injection system for an internal combustion engine according to claim 16, wherein
the fuel seal is an elastic portion that is supported by at least the core.

18. The fuel injection system for an internal combustion engine according to claim 1, wherein
the fuel is supplied to a delivery pipe through one of end portions of the delivery pipe,
the fuel is discharged from the delivery pipe through the other end portion of the delivery pipe, and
each of a fuel-supply-side end portion and a fuel-discharge-side end portion of the fuel passage is connected to the delivery pipe.

19. The fuel injection system for an internal combustion engine according to claim 18, further comprising:
a partition wall that partitions an internal space within the delivery pipe into a first chamber and a second chamber, wherein
the fuel is supplied to the first chamber,
the fuel is discharged from the second chamber, and
the fuel-supply-side end portion of the fuel passage is connected to the first chamber, and the fuel-discharge-side end portion of the fuel passage is connected to the second chamber.

20. The fuel injection system for an internal combustion engine according to claim 19, wherein
the fuel-supply-side end portion of the fuel passage is connected to a flange portion of the first chamber via a shaft seal, and
the fuel-discharge-side end portion of the fuel passage is connected to the second chamber via an area seal.

21. The fuel injection system for an internal combustion engine according to claim 18, wherein
the fuel-supply-side end portion opens into the delivery pipe so as to face an upstream side of the delivery pipe in which the fuel flows.

22. The fuel injection system for an internal combustion engine according to claim 18, wherein
an amount of fuel flowing through the fuel passage during circulation in the fuel injection system is adjusted based on an amount of fuel discharged by a fuel pump, which supplies the fuel to the delivery pipe, or a set pressure at which a relief valve, which discharges the fuel from the delivery pipe, opens.

23. The fuel injection system for an internal combustion engine according to claim 18, further comprising:
a fuel cooling device that is arranged in a fuel discharge passage through which the fuel discharged from the delivery pipe flows, and that cools the fuel.

24. The fuel injection system for an internal combustion engine according to claim 18, wherein
a fuel pump is arranged in a fuel supply line through which the fuel is supplied to the delivery pipe, and
a fuel discharge line, through which the fuel discharged from the delivery pipe is returned to an intake port of the fuel pump, is formed.

25. The fuel injection system for an internal combustion engine according to claim 18, wherein,
a fuel pump is arranged in a fuel supply line through which the fuel is supplied to the delivery pipe,
a first fuel discharge line through which the fuel discharged from the delivery pipe is returned to a fuel tank, and a second fuel discharge line through which the fuel is returned to an intake port of the fuel pump are formed, and
the fuel discharge line, through which the fuel discharged from the delivery pipe is returned, is switched between the first fuel discharge line and the second fuel discharge line based on an operating state of an internal combustion engine.

26. The fuel injection system for an internal combustion engine according to claim 18, wherein
a high-pressure fuel injection system that is used to inject the fuel into a combustion chamber is provided,
the high-pressure fuel injection system includes a low-pressure feed pump and a high-pressure pump, and
at least at a start time of an internal combustion engine, the high-pressure pump is stopped and the fuel is caused to flow through the fuel passage in the high-pressure fuel injection system by the low-pressure feed pump.

27. The fuel injection system for an internal combustion engine according to claim 26, further comprising:
a fuel discharge line, through which the fuel discharged from the low-pressure fuel injection system and the high-pressure fuel injection system is returned to an intake port of the low-pressure feed pump.

28. The fuel injection system for an internal combustion engine according to claim 18, wherein
a low-pressure fuel injection system that is used to inject the fuel to an intake port and a high-pressure fuel injection system that is used to inject the fuel into a combustion chamber are provided,
a low-pressure feed pump that supplies low-pressure fuel to the low-pressure fuel injection system is provided in the low-pressure fuel injection system,
a high-pressure pump that supplies high-pressure fuel to the high-pressure fuel injection system is provided, and
when the high-pressure fuel injection system is stopped, the fuel is caused to flow through the fuel passage in the low-pressure fuel injection system and the fuel passage in the high-pressure fuel injection system by the low-pressure feed pump.

29. The fuel injection system for an internal combustion engine according to claim 28, further comprising:
a fuel discharge line, through which the fuel discharged from the low-pressure fuel injection system and the high-pressure fuel injection system, is returned to an intake port of the low-pressure feed pump.

30. The fuel injection system for an internal combustion engine according to claim 1, wherein
a base end portion of the fuel injection device is connected to a delivery pipe from which the fuel is supplied to the fuel passage, and to which the fuel is discharged from the fuel passage,
the fuel is supplied to the fuel passage through one of an outer peripheral portion and an end portion of the fuel injection device, and the fuel is discharged from the fuel passage through the other of the outer peripheral portion and the end portion of the fuel injection device, and
filters are arranged at the outer peripheral portion and the end portion of the fuel injection device.

31. The fuel injection system for an internal combustion engine according to claim 30, wherein
the filters are arranged so as to cover a fuel-supply-side end portion and a fuel-discharge-side end portion of the fuel passage.

32. The fuel injection system for an internal combustion engine according to claim 1, wherein
an amount of heat received by the front end portion of the fuel injection device is estimated based on an operating state of an internal combustion engine, and a fuel circulation amount is adjusted based on the estimated amount of heat received by the front end portion of the fuel injection device.

33. The fuel injection system for an internal combustion engine according to claim 1, wherein
a temperature of the front end portion of the fuel injection device is estimated, and the fuel is caused to flow through the fuel passage until the estimated temperature is equal to or lower than a predetermined temperature.
